(19) United States
(12) Patent Application Publication
(10) Pub. No.: US 2024/0310654 A1
(43) Pub. Date: Sep. 19, 2024

(54) OPHTHALMIC LENSES WITH OPTIMIZED VISUAL PERFORMANCE

(71) Applicant: Indizen Optical Technologies S.L., Madrid (ES)

(72) Inventors: José Miguel Cleva, Madrid (ES); Eva Chamorro Gutierrez, Madrid (ES); Pablo Concepción, Madrid (ES); José Alonso Fernández, Torrance, CA (US)

(73) Assignee: Indizen Optical Technologies S.L., Madrid (ES)

(21) Appl. No.: 18/605,217

(22) Filed: Mar. 14, 2024

Related U.S. Application Data
(60) Provisional application No. 63/490,140, filed on Mar. 14, 2023.

(51) Int. Cl. G02C 7/02; G02C 7/06

(52) U.S. Cl. CPC G02C 7/028; G02C 7/061

(57) ABSTRACT

Optimizing visual performance of a spectacle lens using metrics of visual performance includes selecting one or more metrics of visual performance for the lens. Creating functions of the metrics of visual performance, each having a function value that decreases as a values of the metrics of visual performance increase. Creating a merit function for lens optimization, the merit function having a main term that contains a weighted sum of functions that decrease as the metrics of visual performance increase, the weighted sum of functions including a set of viewing directions or a set of points with a one-to one correspondence with the set of viewing directions. Minimizing the merit function to optimize lens surfaces. Then designing an optimal lens having the optimized lens surfaces to optimize visual performance.

### RELATED APPLICATION INFORMATION

This patent claims priority to U.S. Provisional Application No. 63/490,140 filed Mar. 14, 2023, which is incorporated herein in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the reproduction by anyone of the patent disclosure as it appears in the Patent and Trademark Office patent files or records, but otherwise reserves all copyright and trade dress rights whatsoever.

### BACKGROUND

### Field

This disclosure relates to ophthalmic lenses, and more specifically to progressive power lenses (PPLs) with optimized visual performance using metrics of visual performance. The PPLs have far vision region sizes, intermediate vision region sizes and near vision region sizes to optimize visual performance based on merit functions including the eye tracking parameters.

### Related Art

Ophthalmic lenses improve the vision of a wearer. Advanced (or customized) ophthalmic (e.g., spectacle) lenses may be designed and manufactured in an attempt to increase the satisfaction of a wearer including by compensating for refractive errors and/or presbyopia. Ophthalmic lenses have aberrations the same way as all the optical systems do. Because the complete optical system involving vision comprises the ophthalmic lens and the eye, ophthalmic lenses may be mainly affected by the so-called second-order aberrations, that is, oblique power error and oblique astigmatism. They also present third-order aberrations which are small because of the smallness of the eye pupil in relation to the size and radii of the ophthalmic lens. Field aberrations are also present: field curvature is incorporated into the second-order power error and distortion. Finally, transverse and longitudinal chromatic aberrations are also present.

The aberrations affecting “vision sharpness” the most, may be power error and astigmatism. For any given viewing direction labeled with the index i, P₀ᵢ and C₀ᵢ can be the target spherical and astigmatic (cylindrical) powers the lens should provide for sharp vision at this viewing direction. Because of the presence of second-order aberrations, the lens will instead provide powers Pᵢ and Cᵢ. In general, producing a lens in which Pᵢ=P₀ᵢ, and Cᵢ=C₀ᵢ, for all gaze directions, is impossible. Then, a balance must be sought, where for some critical gaze directions the differences (Pᵢ−P₀ᵢ) and (Cᵢ−C₀ᵢ) are negligible, but for other non-critical gaze directions the same differences can (and must) be larger. A merit function (1) for lens design would have the general form:

$$M = {\sum }_{i = 1}^{N} {γ}_{i} [ {( {P}_{i} - {P}_{i 0} )}^{2} + {( {C}_{i} - {C}_{i 0} )}^{2} ] + {\sum }_{j = 1}^{K} {\sum }_{i = 1}^{N} {β}_{ij} {T}_{ij}^{2} , \qquad ( 1 )$$

where N is the total number of gaze directions, γᵢ are weights controlling the importance of gaze direction i when reducing power and astigmatic errors, T represents other aberrations the designer wants to be considered, so that Tᵢⱼ is the value of aberration j at gaze direction i, βᵢⱼ are weights controlling the importance of aberration Tⱼ at gaze direction i, and finally K is the number of extra aberrations to be considered. The output number, M is called the “merit” of the merit function (1).

Designing and/or manufacturing a lens may be equivalent to computing its surfaces such that the merit is minimal, henceforth the lens has minimal aberrations according to the selected weight structure. For ophthalmic lenses, the first sum in the merit function (1) may be the important one, the second sum only providing minor corrections to the final design.

The errors (Pᵢ−P₀ᵢ) and (Cᵢ−C₀ᵢ) cause the image to be blurred; they can be considered as spherical and astigmatic defocus. In general, the smaller the values of these errors, the better the vision will be. However, the two of them cannot be zeroed for all gaze directions, so attention must be paid to the effect these errors produce in vision quality. For example, there are threshold values for both errors below which the user will not notice them, these thresholds being around 0.2 Diopter (D). Also, the astigmatic error (Cᵢ−C₀ᵢ), typically has a smaller impact on vision quality. Similarly, a large error at a viewing direction seldomly used should not be given too much weight.

In order to create merit functions yielding a more direct relationship with the actual visual quality of the ophthalmic lens user, many designers have opted for combining the power and astigmatic errors into visual acuity (VA). Visual acuity is routinely measured by the eye doctor, and it quantifies the ability of the eye to resolve fine details. In particular, logMAR (Logarithm of the Minimum Angle of Resolution) visual acuity is defined as the logarithm of the angle subtended by two close points that the eye can barely differentiate. For example, a person with visual acuity 20/20 (0.0 logMAR) should be able to recognize a letter subtending 5 arcmin, but he/she would not be able to recognize any letter smaller than that. A logMAR chart (Logarithm of the Minimum Angle of Resolution)) is a chart consisting of rows of letters that is used by ophthalmologists, orthoptists, optometrists, and vision scientists to estimate visual acuity.

Models have been provided that relate second-order errors with the loss of visual acuity. With such a model, visual acuity can be computed as a function of the second-order errors, Aᵢ=h[Pᵢ, Cᵢ, Pᵢ₀, Cᵢ₀]. These functions may also depend on the user accommodation, the pupil size, and other parameters enriching the visual acuity model. By making use of such a model, a merit function would be transformed into the function (2):

$$M = {\sum }_{i = 1}^{N} {{γ}_{i} ( 1 / {A}_{i} )}^{2} + {\sum }_{j = 1}^{K} {\sum }_{i = 1}^{N} {β}_{ij} {T}_{ij}^{2} , \qquad ( 2 )$$

where visual acuity would be expressed in decimal notation and the optimization process would minimize merit function M.

However, there is a drawback to the previous approaches, which is particularly important in the design of progressive power lenses (PPLs). This disclosure provides PPLs optimized according to visual performance, rather than visual acuity or power error and astigmatism. Visual performance metrics can be based on eye tracking parameters or can be directly related to visual task performance metrics, as for example, reading speed and reading comprehension.

### DESCRIPTION OF THE DRAWINGS

FIG. 1A shows a distribution of the three regions of a progressive power lens (PPL) for a balance, distance and near PPL.

FIG. 1B shows a distribution of the three regions of a PPL having sizes that are optimized using a merit function incorporating visual performance metrics to provide optimized visual performance for the PPL.

FIG. 1C is an example graph of how fixation time grows with power errors and with diminishing font size.

FIG. 1D is an example graph of how reading time grows with power errors and with diminishing font size.

FIG. 1E is an example graph of how a target zone size is determined by minimizing a merit function.

FIG. 2 shows experimental study fixation classification examples from a gaze position signal.

FIG. 3 shows a flowchart for participant enrollment and data analysis for the experimental study.

FIG. 4 shows variations in test duration, complete fixation time, and fixation count depending on the interactions of eye chart size and gaze direction, the gaze directions and PPL, and PPL and eye chart for far-distance VA task.

FIG. 5 shows variations in test duration, complete fixation time, and fixation count depending on the interactions of eye chart size and gaze direction, the gaze directions and PPL, and PPL and eye chart in for near-distance VA task.

FIG. 6 is a flow diagram of an operating environment/process for providing optimized visual performance of a PPL.

FIG. 7 is a block diagram of a computing device.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

The methods, devices, systems and lenses described herein provide spectacle lenses, such as progressive power lenses (PPLs) with optimized visual performance. They may provide a PPL spectacle lens having a far vision region size, an intermediate vision region size and a near vision region size designed or optimized using a merit function incorporating visual performance metrics that are either: 1) directly measured, as reading speed, reading comprehension, or shape recognition time; 2) or eye-movement parameters obtained with eye-tracking technology that have a direct relationship with visual performance, the parameters including a number of fixations, a fixation time, a total fixation time, or a number of fixation regressions. They may provide merit functions created for lens optimization in which parameters describing visual performance are used instead of visual acuity and/or power and astigmatism errors. The parameters describing visual performance may include or be reading speed or time; and/or number of fixations. PPLs typically include three different regions intended for viewing at different distances. The regions are a far vision region having a far vision region size, an intermediate vision region having an intermediate vision region size and near vision region having a near vision region size. These three sizes may be optimized by minimizing the merit function.

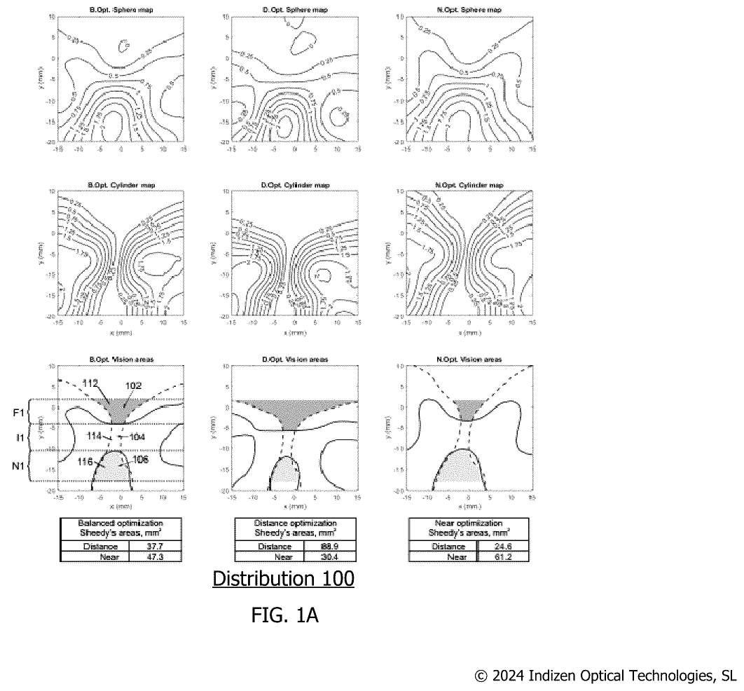

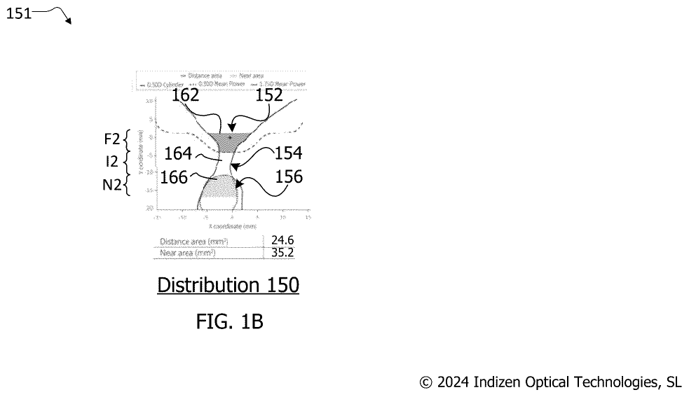

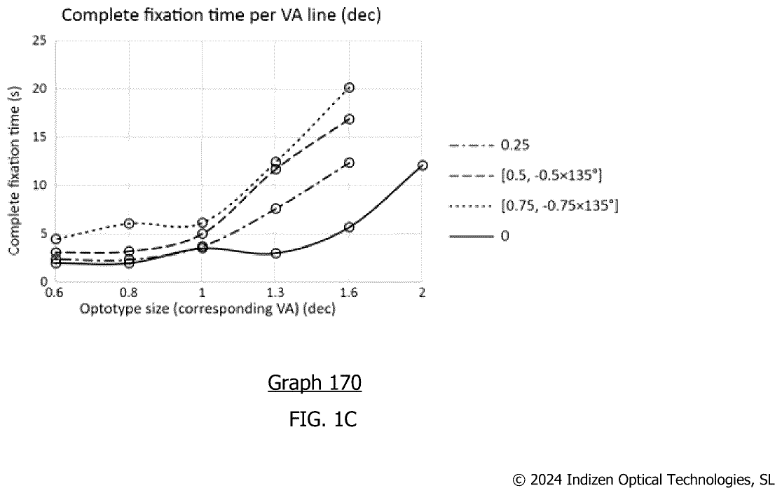

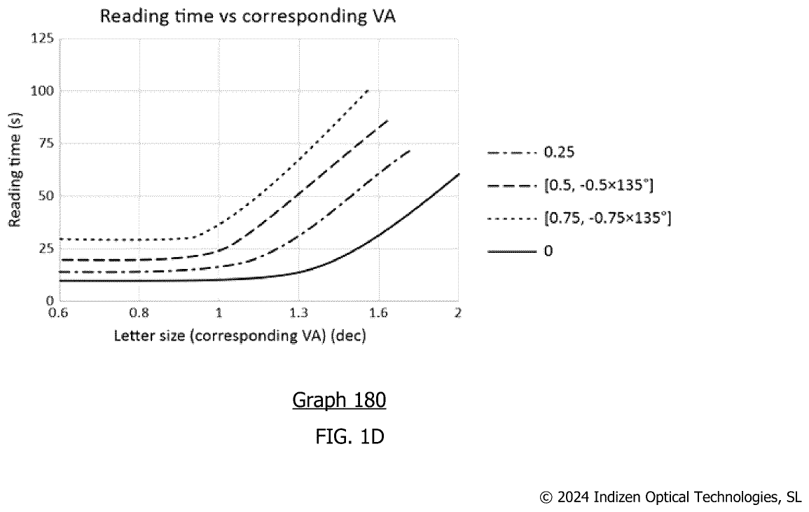

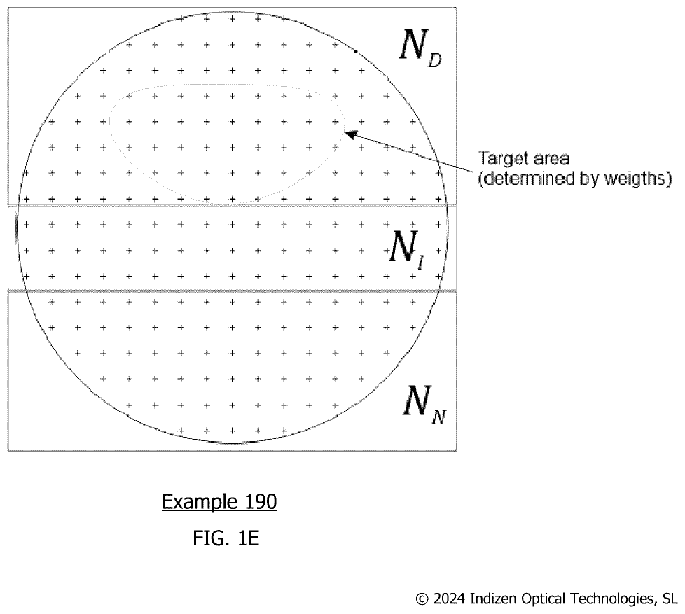

FIG. 1A shows a distribution 100 of the three regions of a PPL. Distribution 100 shows a PPL balanced column A, then a PPL distance column B, then a PPL near column C. Each column A, B and C of FIG. 1A shows graphics of: a mean power distribution map through the lens surfaces at the top; a cylinder power distribution map through the lens surfaces below that; and an X,Y coordinate graph of distance areas, intermediate areas and near visual areas through the lens surfaces, at the bottom, according to Sheedy's criteria for a Plano prescription, addition 2 Diopter (2D) with default personalization parameters.

At the bottom of column A, the X, Y coordinate graph shows a far distance region 102 for viewing distant objects, a near distance region 106 below region 102 for viewing near objects, and a small intermediate distance region 104 between regions 102 and 106 for viewing at intermediate distance objects. Regions 102, 104 and 106 have far/distance vision area 112, intermediate vision area 114 and near vision are 116 which are 2 dimensional representations of the vision region sizes represented by brackets F1, I1 and N1 to the left of the X, Y coordinate graphs. That is, bracket F1 represents the size of far area 112, bracket N1 represents the size of near area 116, and bracket I1 represents the size of small intermediate region area at 114 between F1 and N1. If we set a uniformly distributed grid of measuring point in the X, Y coordinate graphs, the size F1, I1 and N1 of each of the regions can be described as the count of the points of or in the area 112, 114 and 116 of that region. Each graphic of FIG. 1A may show a grid of uniformly distributed points in the graph where the grid is dense enough, so that the area/size of a region 102, 104 and 106 is proportional to the number of points inside the region. In the case of bitmap images (e.g., the sphere and cylinder maps), the image is constructed out of pixels. The area/size of a given region is then proportional to the number of pixels inside the region.

These regions, areas and sizes also apply to the corresponding locations in the upper two graphics for mean power and cylinder power of the columns of FIG. 1A. Below the X, Y coordinate graphs, tables list the numerical vision region sizes for F1 and N1 of the distance vision areas and near vision areas, respectively. FIG. 1A will be explained further below with respect to the experimental data and relationships.

Each of the sizes F1, I1 and N1 of the regions 102, 104 and 106 is usually determined by the errors (Pᵢ−P₀ᵢ) and (Cᵢ−C₀ᵢ) of that region. For example, for the size F1 of far distance region 102, P₀ and C₀ correspond to the prescription of the individual. The far region size F1 could be defined as the collection of points (e.g., area 112) on the back surface of the lens, (xᵢ, yᵢ), where the conditions (3) below are met:

$$\vert {P}_{i} - {P}_{0} \vert < 0.25 AND \vert {C}_{i} - {C}_{0} \vert < 0.5 , \qquad ( 3 )$$

and where there is a one-to-one correspondence between a surface point (xᵢ, yᵢ) and the viewing direction i passing through it. Similar conditions involving user accommodation and lens addition are used to define the intermediate region size I1 (or area 114) and the near region size N1 (or area 116). These region sizes F1, I1 and N1 (or areas) can be defined as the number or count of the collection of points i to N_{F}, j to N_{I}, and k to N_{N} on the back surface of the lens, (xᵢ, yᵢ).

Since the implementation of progressive lenses or PPLs in the beginning of the 20th century, many designs have been brought into the market with different sizes F1, I1 and N1 for the far, intermediate and near vision regions. In general, increasing the size of one of these regions spoils or reduces the size of the other regions, or otherwise introduces unacceptable levels of astigmatism at the lateral regions of the lens, so an overall balance or optimization must be sought. A lens specifically designed for far vision would have a larger far vision region size at the expense of a slightly reduced intermediate and/or near region sizes. Similarly, a lens specifically designed for near vision would have a larger near vision region size at the expense of a slightly reduced intermediate and/or far region sizes, and so on.

If we compare a balanced progressive lens in column A with a progressive lens specifically designed for far vision column B, where the region sizes are determined according to conditions (3), we expect that the size F1 of the region with high far-vision visual acuity of column B would be larger than the sizes I1 and NI of each of the other regions in the lens specifically designed for far vision, such as shown in distribution 100. However, experiments where visual acuity is measured while wearing these types of lenses do not provide that expected output. Instead, unliked distribution 100, in the experiments, the size F1 of the region with optimal far-vision visual acuity may be equal for both lenses of columns A and B; or may even be smaller for the lens optimized for far vision of column B than that of column A or C. The same happens for lenses optimized for near vision of column C or intermediate vision of column A. Here are two reasons for this counterintuitive outcome:
A. The measurements of clinical visual acuity are noisy with relatively low repeatability. The procedure is tiresome for the individual, and the result is heavily dependent on non-optical factors as fatigue levels and tear quality.
B. The individual struggled with the recognition of letters at the edge of the field of view, where the power and astigmatic errors get close to the thresholds. A little bit more blur triggers some more struggle and recognition ability, while some less blur reduces the visual stress but does not necessarily increase visual acuity.

In the end, visual acuity turns out not being a good predictor of the frontier between “good vision” and “bad vision” in ophthalmic lenses. Metrics other than visual acuity or power and astigmatic errors may be better for determining the region sizes of PPLs.

It is necessary then to use better predictors for “good vision” and “bad vision” in order to properly define the sizes of the far, intermediate and near regions.

FIG. 1B shows a distribution 150 of the three regions of a PPL 151 having region sizes F2, I2 and N2 of a PPL that are optimized using a merit function incorporating visual performance metrics to provide optimized visual performance for the PPL. Clinical results may be used to determine distribution 150.

Sometimes the distinction between a metric and a parameter is clear, sometimes is more fuzzy. In some cases, a metric is a number or a set of numbers that allows rating of some physiological function. For example, quality of vision may be rated using visual acuity. It is a metric because, somehow, it measures quality of vision. Visual acuity may be computed with a model represented by a mathematical function. Then some parameters may enter this function, for example, pupil diameter. Pupil diameter does not measure visual quality, it is not a metric. But visual acuity, which somehow characterizes visual quality, depends on the pupil diameter.

Now, if you consider eye-tracking technology, it provides a lot of parameters characterizing eye-movement. Some of these parameters can be directly related to visual performance. For example, when reading, the eye does fixations and regressions. The shorter the duration of the fixations, the faster the person is reading. Thus, the duration of fixations, being among the parameters delivered by eye-tracking, turns into a metric of visual performance.

To summarize, “parameter” may be a very general word describing a numerical variable that may represent a physical property, or may be part of a mathematical formula. When the value of the parameter rates visual performance, it becomes a metric for visual performance. Also, a metric of visual performance may be given by a function of many different parameters.

Distribution 150 shows an X,Y coordinate graph of distance areas, intermediate areas and near visual areas through the lens surfaces of PPL 151, according to embodiments herein for a Plano prescription, addition 2 Diopter (2D) with default personalization parameters. The X,Y coordinate graph shows a far distance region 152 for viewing distant objects, a near distance region 156 below region 152 for viewing near objects, and a small intermediate distance region 154 between regions 152 and 156 for viewing at intermediate distance objects. Regions 152, 154 and 156 have far/distance vision area 162, intermediate vision area 164 and near vision area 166 which are 2 dimensional representations of the vision region sizes represented by brackets F2, I2 and N2 to the left of the X,Y coordinate graph. That is, bracket F2 represents the size of far area 162, bracket N2 represents the size of near area 166, and bracket I2 represents the size of small intermediate region area at 164 between F2 and N2. The size F2, I2 and N2 of each of the regions can be described as the count of the points of or in the area 162, 164 and 166 of that region of PPL 151. Here, the size F2, I2 and N2 may be the “points” that are uniformly distributed across the lens surface, or, for maps represented by matrices of pixels, “point” may be “pixel”. The uniform distribution may be a grid of uniformly distributed points as explained for FIG. 1A.

Below the X, Y coordinate graph, a table lists the numerical vision region sizes for F2 and N2 of the distance vision areas and near vision areas, respectively. FIG. 1B will be explained further below.

While visual acuity does not discriminate between three different PPL designs of columns A, B and C of FIG. 1A (one balanced, one optimized for far vision and one optimized for near vision), some eye-tracking parameters related to eye movement and recognition speed do correlate with the progressive design. In the eye-tracking parameter of time needed for completing the measurement of visual acuity for far vision is smaller for the lens optimized for far vision, and the result has statistical significance. Similarly, the eye-tracking parameter of time needed for completing the measurement of visual acuity for near vision is smaller for the lens optimized for near vision. The conclusion is then that the user may obtain the same visual acuity with slightly different values of power and astigmatic errors, but he/she will finish the test faster with the lens giving the smaller error values. The faster test can be used to determine or may indicate optimized visual performance.

Similar trends can be found for the eye-tracking parameter of total number of fixations and the total fixation time during the measurement of visual acuity. Fixations are among the parameters determining the eye movement when executing a visual task and can be measured with eye-tracking devices. The total number of fixations and/or the total fixation time can be used to determine or may indicate optimized visual performance.

For example, different tests may be used to assess “visual performance”, that is, the capacity to perform a visual task comfortably, effortlessly, rapidly, or swiftly, or a combination of any of them. Metrics for visual performance may include reading speed, reading comprehension, and a plethora of static or dynamic tests involving geometrical shapes, signs, symbols or images in general that can be presented in digital displays. For example, reading speed correlates with eye movement statistics involving low number of fixations, low number of regressions, and small-duration fixations. So, these eye-movement parameters may correlate well with visual performance. In some cases, reading speed is substituted with reading time, as appropriate for the descriptions and functions herein.

Embodiments herein include creating merit functions for lens optimization in which parameters describing visual performance are used instead of visual acuity and/or power and astigmatism errors. Creating one or more such merit functions may include:
A. Selecting one or more metrics of visual performance;
B. Establishing a relationship between power and astigmatic errors and the metrics of visual performance, either through experiment or modeling;
C. Creating one or more functions of the visual performance metrics whose values decrease as the values of the visual performance metrics increase;
D. Creating a merit function for lens optimization such that the merit function's main term contains a weighted sum of functions that decrease as the visual performance metrics increase, the sum running across a set of viewing directions or a set of points with a one-to one correspondence with the viewing directions. The merit function may have other terms to control the existence and properties of an umbilical line, or for the reduction of less-importance aberrations; and
E. Minimizing this merit function with one or more minimization algorithms to determine or lead to optimal lens surfaces, and henceforth, optimal lenses regarding visual performance. Minimizing here may lead to or optimize the regions sizes to be F2, I2 and N2 of a PPL to provide optimized visual performance for the PPL. Minimizations algorithms that can be used to minimize the type of merit functions may be well known algorithms to any expert in the field. For example, a well suited one is the gradient descent based method Broyden-Fletcher-Goldfarb-Shanno (BFGS), that can uses the numerical computation of the Hessian to find descent direction. Global methods such as genetic minimization algorithms or simulated annealing are also very effective to find global minima of the merit functions described below.

In one case, an experimental relationship between reading speed and blur is first established. Here, reading speed or reading time may be an eye-tracking parameter or a metric of visual performance. For this, a clinical trial can be arranged in which the participants are asked to read a text under different levels of blur artificially introduced with trial lenses, the blur being produced with different amounts of power and astigmatic errors. Functions of the type of function (4) below:

$$RT = {f}_{F} ( {t}_{s} , {E}_{P} , {E}_{A} ) \qquad ( 4 )$$

are fitted to the experimental data, where RT is reading time, tₛ is the type size, E_{P}=(P−P₀) is the power error and E_{A}=(C−C₀) is the astigmatic error. The function f_{F} fits the experimental data when the text is presented at a distance larger than 6 meters (far distance vision). There are similar functions f_{I} and f_{N} for intermediate and near distances, and the three of them may depend on more parameters related with the setup or with the subject, these parameters not being explicitly shown for conciseness.

It is possible to measure Fixation time (e.g., how function f_{F} can be determined) when identifying letters, and experimental evidence shows that reading time behaves exactly the same. FIG. 1C is an example graph 170 of how fixation time grows with power errors and with diminishing font size. FIG. 1D is an example graph 180 of how reading time grows with power errors and with diminishing font size. Graphs 170 and 180 may not be the outcome of a real experiment. Graphs 170 and 180 may be a composition using values from a different experiment (fixation times) and knowledge that reading time and fixation time correlate very well.

An example of function f_{F} is shown by graph 170 and/or 180. The solid and dotted line functions represent a model obtained from experimental data on reading times with different font sizes. The font size is given as “corresponding visual acuity” (VA) which means the minimum visual acuity required to resolve the letter at the relevant viewing distance. Corresponding visual acuity CAV, font size s, and viewing distance d, are related through the expression CVA=1.45×10⁻³ d/s.

Now, three regions are defined in a would-be progressive lens. A far vision region 102 around the Distance Reference Point (DRP), a near vision region 106 around the Near Reference Point (NRP), and an intermediate near region 104 around the center of the corridor connecting the DRP and the NRP. The indexes i, j and k will label points inside each of these regions, where N_{F}, N_{I} and N_{N} the total number of points in each region which as subset of may be total numbers defining sizes F2, I2 and N2, respectively. That is, a subset of a count from 1 (for each of indexes i, j and k) to each of N_{F}, N_{I} and N_{N} may be three numbers defining sizes F1, I1 and N1, respectively. Each point of the indexes has a corresponding viewing direction, sharing the same index, and for each viewing direction the lens will have some power errors, E_{P}_{ᵢ}, E_{P}_{ⱼ} and E_{P}_{ₖ}, and some astigmatic error, E _{A}_{ᵢ}, E_{A}_{ⱼ} and E A_{K}. Next, a merit function (5) is created as follows:

$$M = {\sum }_{i = 1}^{{N}_{F}} {ϕ}_{i} {f}_{F} ( {E}_{{P}_{i}} , {E}_{{A}_{i}} ) + {\sum }_{j = 1}^{{N}_{I}} {ι}_{j} {f}_{I} ( {E}_{{P}_{j}} , {E}_{{A}_{j}} ) + {\sum }_{i = 1}^{{N}_{N}} {v}_{i} {f}_{N} ( {E}_{{P}_{k}} , {E}_{{A}_{k}} ) + Φ , \qquad ( 5 )$$

where ϕ, ι and ν are weights for the far, intermediate and near regions, respectively, and any parameters other than the second-order errors are omitted in the functions “f” providing the reading time. Finally, Φ stands for a portion of the merit function that may consider structural parameters of the progressive lens (corridor inset, imposition of umbilicality down the corridor, and maximum values of the lateral astigmatism). It may also take into consideration third order aberrations, distortion, chromatic aberration and or lens thickness or weight. The minimization of this merit function (5) with minimization algorithms may lead to optimal lens surfaces, and henceforth, optimal lenses regarding visual performance for those cases in which maximum visual acuity is not needed.

An example of implementing effective merit function (5) using Visual Performance may be performed by starting with a lens having a non-optimal surface. Evaluating the merit function (5) for this lens gives a number, “the merit” of the lens. Next, the optimization algorithm is rune and the minimization may take many steps. In each step where the free form surface may is changed, the merit function is re-computed and if the merit is smaller, the change in the surface is accepted. The process is repeated, tens, hundreds or thousands of times until there is no modification to the surface that yields a smaller merit. Thus, the minimization is complete. Here, N_{F}, N_{I} and N_{N} may not be determined during optimization. They are the points (or viewing directions) in each region used to compute the merit. These numbers depend on the grid of points (viewing directions) we use to optimize the lens. A similar minimization process can be used for function (7).

The advantage of a merit function as the one portrayed in function (5) is that the minimized function (5) and/or sizes F2, I2 and N2 (fields of view) of the far, intermediate and near regions, are determined by the ability to read fast, rather than to achieve maximum visual acuity. The latter may seem desirable but may not be practical when the amount of blur is large, because a blurred letter can be recognizable with effort, but that does not provide comfort, speed of execution, or agility, to the visual task (e.g., but that does not provide optimized visual performance). Here, the amount of blur may be large with maximum visual acuity. For example, in some cases, text is being read in the far region with corresponding visual acuity 0.9 (while our maximum visual acuity is 1.2). Since the maximum VA is larger than the corresponding VA of the text, reading here is easy. Now, the lens will introduce power errors at the lateral regions of the field of view. Assume the power error at 20° to the nasal side is 0.5 D, which reduces our VA from 1.2 to 0.9. Then, at 20° nasal the text can still be read, but because the text is in the very limit of resolution, there is a struggle for reading at this point in the field of view. If VA is used as a metric in the merit function, and the threshold is set to 0.9, the width of the field of view will be 20°. However, if a Visual Performance metric is used, for example, reading time, and thresholds are imposed for the reading to be fast and comfortable, the field of view must be smaller. The 0.5 D of blur gotten at 20° is too much for comfortable reading, though the text can still be recognized.

In one case, an experimental relationship between a number of fixations per character and blur is first established. Here, the number of fixations per character may be an eye-tracking parameter or a metric of visual performance. For this, a clinical trial is arranged in which the participants are asked to read a distant text subtending at least 40° vertically and 40° horizontally, under different levels of blur artificially introduced with trial lenses, the blur being produced with different amounts of power and astigmatic errors. Functions of the type of function (6) below

$$NF = g ( {t}_{s} , {E}_{P} , {E}_{A} ) \qquad ( 6 )$$

are fitted to the experimental data, where NF is the number of fixations, t_{S} is the type size, and E_{P} and E_{A} are the power and astigmatic errors, respectively. The function g fits the experimental data when the text is presented at a distance larger than 6 meters (far distance vision) and may depend on more parameters related with the setup or with the subject, these parameters not being explicitly shown for conciseness. Similar functions can be obtained for other metrics, such as total/and or average fixation time, or number of regressions. The behavior to determine function g may be similar to that shown for reading time functions (4). For example, it is possible to measure reading speed (e.g., how function g can be determined) when identifying letters, and experimental evidence shows that reading time behaves exactly the same, such as shown in FIGS. 1C-1D.

Next, a merit function (7) is created for single-vision lenses as follows,

$$M = {\sum }_{i = 1}^{N} {γ}_{i} g ( {E}_{{P}_{i}} , {E}_{{A}_{i}} ) + Φ , \qquad ( 7 )$$

where the index i labels the points/gaze directions within a 20° Cone around the visual axis, γᵢ are weights for the i-point and E_{P}_{ᵢ} and E_{A}_{ᵢ} are the power and astigmatic errors for point/gaze direction i. The remaining merit function Φ takes into consideration other, secondary lens performance factors, as third order aberrations, chromatic aberrations, distortion, lens thickness or lens weight. Instead of maximizing visual acuity, that can be achieved with great effort of the user, the merit function shown in (7) will deliver a lens design that will minimize the number of fixations during reading a far-located text within a 40° Field of view. The resulting lens will provide better visual performance for far vision reading. The minimization of this merit function (7) with minimization algorithms may lead to optimal lens surfaces, and henceforth, optimal lenses regarding visual performance for those cases in which maximum visual acuity is not needed.

Here, N may be the total number of points in all regions which has a subset that may be a total numbers defining one of sizes N2, I2 or F2; or a size of a single region for a normal single region lens or non-PPL. That is, a subset of a count from 1 of index i to N may be a number defining size F2 for a nearsighted lens.

Here, N or the size of the region (e.g., a subset of N) may not be determined by optimization, but determined by the grid of points/viewing directions used to optimize the lens, similar to determining N_{F}, N_{I} and N_{N} of function (5). In some cases, merit functions (5) and/or (7) may use grids of 40×40 points/viewing directions, that is 1600 uniformly distributed in the whole lens. From these, about 500 will be in the far region, about 100 in the intermediate region, about 300 in the near region and the remaining 700 points in the laterals of the lens (e.g., those would appear in the term Φ).

An example of implementing effective merit function (7) using Visual Performance may be performed by starting with a lens having a non-optimal surface. Evaluating the merit function (7) for this lens gives a number, “the merit” of the lens. Next, the optimization algorithm is rune and the minimization may take many steps. In each step where the free form surface may is changed, the merit function is re-computed and if the merit is smaller, the change in the surface is accepted. The process is repeated, tens, hundreds or thousands of times until there is no modification to the surface that yields a smaller merit. Thus, the minimization is complete. Here, N may not be determined during optimization. It is the points (or viewing directions) in the region used to compute the merit.

The advantage of a merit function as the one portrayed in function (7) is that the minimized function (7) and/or size F2 (field of view) of the far region is determined by the ability to reduce the number of fixations per character, rather than to achieve maximum visual acuity. The latter may seem desirable but may not be practical when the amount of blur is large, because a blurred letter can be recognizable with effort, but that does not provide comfort, speed of execution, or agility, to the visual task (e.g., but that does not provide optimized visual performance). Here, the amount of blur may be large with maximum visual acuity. An example is given for function (5).

In one special example, for certain visual tasks, or for certain visual conditions, the ability to perform comfortably, effortlessly, rapidly, or swiftly, or any combination of them does not always require the smallest power values for the power and astigmatic errors. For example, consider a certain visual task in which some text with large type size must be read. Because the letters are big, the task can be performed effortlessly and rapidly even if some non-negligible second-order errors (e.g., power and astigmatic errors) are present across the field of view.

In another special example, a subject suffering from some foveal dysfunction causing low vision condition will be unaware of the presence of blur due to non-negligible second-order errors, as the resolution of the usable portions of its retina is very low.

In these special examples, the functions (4) and (6) must be adjusted, either because the visual task is low-demanding or the individual has large tolerance to defocus due to a low-vision condition. Here the functions f_{F,I or N} (E_{P}_{ᵢ}, E_{A}_{ᵢ}) and g(E_{P}_{ᵢ}, E_{A}_{ᵢ}) can be called the adjusted functions f_{low}(Eₚ, E_{A}) and g_{low}(Eₚ, E_{A}). The merit functions (5) and (7) can be constructed with the functions flow and glow instead of f (e.g., f_{F,I or N}) and g, respectively. The resulting lenses will optimize visual performance for those cases in which maximum visual acuity is not needed. The behavior to determine functions f_{low}(Eₚ, E_{A}) and g_{low}(Eₚ, E_{A}) may be similar to that shown for reading time functions (4). For example, it is possible to measure reading speed (e.g., how functions f_{low}(Eₚ, E_{A}) and g_{low}(Eₚ, E_{A}) can be determined) when identifying letters, and experimental evidence shows that reading time behaves exactly the same, such as shown in FIGS. 1C-1D.

The advantage of merit functions (5) and (7) can be constructed with the functions flow and glow is that the metric function, and/or sizes F2, I2 and N2 (fields of view) of the far, intermediate and near regions, are determined by the ability to read fast and/or number of fixations considering certain visual tasks or certain visual conditions, rather than to achieve maximum visual acuity.

In some cases, spectacle lenses are designed with merit functions incorporating visual performance metrics, either directly measured, as reading speed, shape recognition time, etc., or eye-movement parameters obtained with eye-tracking technology that have a direct relationship with visual performance, as number of fixations, fixation time, total fixation time, and number of regressions. These visual performance metrics can be related to second order power and astigmatic errors either through fitting of experimental data or through modelling. Certain regions in the lens, can be defined in terms of angular field-of view or in terms of collections of points in either of the lens surfaces. These regions are given a merit value as the sum of the values of the visual performance metrics times a weight for each point or viewing direction within each given region. An optimization algorithm is run to minimize the merits corresponding to each region, using as minimization parameters the coefficients describing one or the two surfaces of the lens. The minimized merit functions provide better lens design or the optimized sizes F2, I2 and N2 (fields of view) of the far, intermediate and near regions.

An example of implementing this effective merit function is similar to that explained for function (5) and/or (7), such as using Visual Performance performed by starting with a lens having a non-optimal surface, then evaluating the merit function.

In some cases, the functions relating visual performance and second-order power and astigmatic errors are obtained for cases where maximum visual acuity is not needed, either because the lens is intended for low-demanding visual tasks or for users with high tolerance to defocus, for example subjects with low-vision condition. These minimized merits provide better lens design or the optimized sizes F2, I2 and N2 (fields of view) of the far, intermediate and near regions.

As noted, FIG. 1B shows a distribution 150 for a lens design having a minimized merit function herein and/or of the three regions of a PPL 151 having region sizes F2, I2 and N2 that are optimized using a merit function incorporating visual performance metrics. PPL 151 may be a PPL that is optimized, minimized, designed, fabricated and/or manufactured having a minimized merit function herein and/or a far vision region size F2, a intermediate vision region size I2 and a near vision region size N2 designed or optimized using a merit function (e.g., function (5) and/or (7)) incorporating visual performance metrics that are either: 1) directly measured, as reading speed (e.g., function (5)) or shape recognition (e.g., function (7)) time; 2) or eye-movement parameters obtained with eye-tracking technology that have a direct relationship with visual performance, the parameters including a number of fixations, a fixation time, a total fixation time, or a number of fixation regressions, wherein the visual performance metrics are related to second order power and astigmatic errors either through fitting of experimental data or through modelling (e.g., function (5) and/or (7)). The minimized merit function herein and/or region sizes F2, I2 and N2: 1) are defined in terms of angular field-of view or in terms of collections of points in at least one lens surface, and 2) are given a merit value as the sum of the values of the visual performance metrics times a weight for each point or viewing direction within each given region, and 3) the merit values are minimized using an optimization algorithm that uses as minimization parameters, coefficients describing the at least one surface of the lens.

The visual performance metrics may include reading time and number of fixations but exclude visual acuity errors, visual power errors and astigmatism errors. The at least one surface may be either or both a front and a back surface of the lens. The functions relating visual performance and second-order power and astigmatic errors may be obtained for cases where maximum visual acuity is not needed, either because the lens is intended for low-demanding visual tasks or for users with high tolerance to defocus, for example subjects with low-vision condition.

The PPL 151 may be a spectacle lens having a minimized merit function herein; and/or a far vision region size F2 determined by a total number of points N_{F}, an intermediate vision region size I2 determined by a total number of points NI, and a near vision region size N2 determined by a total number of points N_{N} that provide optimized visual performance by minimizing a metric function.

In some cases, minimizing the metric function may include or be minimizing the experimental relationship between reading time (or reading speed) and reading time blur (e.g., of merit function (5)) that when minimized for reading time (e.g., see step E). The a minimized merit function may be used to determine: a total number of a subset of points N_{F} of index points i inside the far vision region 152, wherein the total number of a subset of points N_{F} is the far vision region size F2; a total number of a subset of points N_{I} of index points j inside the intermediate vision region 154, wherein the total number of a subset of points N_{I} is the intermediate vision region size I2; and a total number of a subset of points N_{N} of index points k inside the near vision region 156, wherein the total number of a subset of points N_{N} is the near vision region size N2.

In some cases, minimizing the metric function may include or be minimizing the experimental relationship between number of fixations per character and a fixations per character blur (e.g., of merit function (7)) that when minimized for fixations per character (e.g., see step E) determines: a subset of a total number of points N of index points i inside the far vision region 152, wherein the total number of a subset of points N is the far vision region size F2 or is the region size for a single zone lens.

In either case, the visual performance metrics may include reading time and number of fixations, but exclude visual acuity errors, visual power errors and astigmatism errors. Minimizing the reading time may provide comfort, speed/time of execution, or agility, to the visual task. Minimizing the number of fixations per character may minimize the number of fixations during reading of a far-located text within a 40° Field of view to provide better or optimized visual performance for far vision reading.

FIG. 1E is an example 190 graph of how a target zone size is determined by minimizing a merit function. Example 190 regards the number of points used in the merit function, Nd, Ni, Nn, which are different than the subset of those points which may be total number of points in the useful or target areas as defined in FIGS. 1A-B.

In example 190, the circle represents the contour of the lens to be optimized. The grid of points contains the points at which are going to be used compute the lens properties. Nd, Ni and Nn are the number of points in three regions of the lens that are devoted to distance vision, intermediate vision and near vision.

For the distance region, there are Nd points in this region (enclosed within the red rectangle). The weights in the merit functions are chosen so that a target region within the far region would have the metrics used in the merit function below some threshold. In the figure, the target region is shown in the orange curved shape. The objective of the merit function is to make the lens “good” within the target region by letting the aberrations grow outside it. It is unknown “a priori” how many points will be in the target region that is, it is unknown how large the area of the lens being “good” will be. This is an outcome of the minimization. Once the lens is optimized, its properties can be computed and the size of the regions can be determined. For this computation a new grid of points can be used (typically much denser than the grid we used for optimization, because computation of the lens properties is very fast, optimization is slow). The final region may match the target, depending on how wisely the weights were selected. The area of the distance region in which the lens is “good” may have nothing directly to do with the number of points Nd used during optimization.

One important fact for this application is how to define the lens to be good. Defining may be or consider using sphere and cylinder errors; using blur (a combination of sphere and cylinder); using visual acuity (a function of blur); and/or using metrics that directly give visual performance, that is, the ability of a person/subject to perform a visual task quickly and effortlessly.

Metrics of visual performance are much more sensitive to the user: If a lens provides a distance region of 40 mm2 with maximum visual acuity, it is not clear what that means from the point of view of usability, because the user may need a great visual effort to achieve maximum visual acuity. If visual performance is good in an area of 40 mm2, that means this area is fully usable for the task that determines the visual performance.

A sensitive assessment or (proposed) study of visual performance is now provided by different progressive lens (e.g., PPL) designs by means of eye-tracking parameters. This assessment may be or include the previously mentioned further explanation of FIGS. 1A-1B with respect to experimental data and relationships. This assessment may also relate the visual performance metrics to second order power and astigmatic errors either through fitting of experimental data and/or through modelling. This assessment may establish a relationship between power errors and astigmatic errors and the metrics of visual performance, such as reading speed/time and/or number of fixations, either through experiment or modeling, such as to create function (4) and/or (6). This assessment also establishes an experimental relationship between reading speed and blur, such as using function (4) and/or (5). In another case, this assessment establishes an experimental relationship between a number of fixations per character and blur, such as using function (6) and/or (7). An objective of this study aims to evaluate an eye-tracking-based method for assessing the quality of vision with progressive power lenses by analyzing test duration and eye fixations during a high-contrast visual acuity test. The study may provide improved PPL designs using metrics of visual performance.

A method of the study records the pupil position of 27 PPL users (e.g., experiment participants or test subjects) during high contrast visual acuity measurement at near and distance vision using a wearable eye tracker system (e.g., Tobii-Pro Glasses 3) and three different PPL designs: a PPL that is balanced for general use (PPL-Balance), a PPL optimized for distance vision (PPL-Distance), and a PPL optimized for near vision (PPL-Near), such as shown in columns A, B and C of FIG. 1A. Test subjects were asked to recognize several eye charts displayed on a screen at 5.25 m and 0.37 m distance when they used centered and oblique gaze directions with each PPL design. High contrast visual acuity, test duration, complete fixation time, and the number of fixations were analyzed for each distance and PPL. Statistical analyses were performed with Python 3.8.8 software using the statsmodels library.

In the study results, no statistically significant differences were found between progressive lenses or gaze directions neither distance nor near evaluation for high-contrast visual acuity. However, statistically significant differences were found for metrics obtained by the eye-tracker method. The analysis of the eye chart sizes showed a higher test duration (p<0.001*), higher fixation time (p<0.001*), and higher number of fixations (p<0.001*) for smaller optotypes compared to those with a larger size. The analysis of gaze directions showed a statistically significant higher test duration (p<0.05*), higher complete fixation time (p<0.05*), and a higher number of fixations (p<0.001*), at off-axis gaze directions in comparison with centered gaze direction. Lastly, regarding the power distribution of the PPL, it was found a statistically significant lower test duration (p<0.001*), lower complete fixation time (p<0.001*), and lower number of fixations (p<0.001*) for PPL-Distance at distance evaluation and statistically significant lower test duration (p<0.001*), lower complete fixation time (p<0.001*), and lower number of fixations (p<0.001*) for the PPL-Near at near vision.

It can be concluded that the proposed eye-tracked method of the study for assessing the quality of vision with progressive power lenses can evaluate differences in test duration and eye fixation characteristics between progressive lenses with different power distributions, being a more sensitive indicator of the quality of vision than the standard visual acuity evaluation. The study's evaluation of differences in test duration and eye fixation characteristics may provide the experimental data and/or experimental modeling herein. The study addresses high contrast visual acuity, progressive power lenses, eye-tracking and/or eye fixations.

Presbyopia is an age-related condition that prevents focusing on near objects, it is a natural part of the aging process and begins to develop around age 40. Progressive power lenses (PPL) are a popular solution for presbyopes, as they provide a gradual transition of spherical power between distance and near vision, allowing wearers to see clearly at all distances by changing their gaze direction. Due to the power variation along the vertical main meridian, usually an umbilical curve, unwanted astigmatic and spherical power variations appear in the lateral areas of the lens and affect the quality of vision. One of the main ways to assess the quality of vision with PPL is through high-contrast visual acuity (VA). VA may refer to the ability to discern object details subtending a certain angle and is commonly employed in clinical practice to measure vision quality. VA is also the standard measure to assess the quality of an optical correction. The measurement of VA has been extensively used to evaluate the impact of lateral refractive errors of PPLs in visual performance. One study evaluated differences in VA with 2 different PPLs and reported worse VA values when viewing through the lateral regions of the lens in comparison with the central region. Another study evaluated of the effect of off-axis refractive errors of a PPL and showed a reduction of VA at off-axis gaze directions in comparison with centered gaze directions. However, these studies have not found significant differences in VA scores between different types of PPLs. This could be because the VA score does not consider other factors that impact visual perception, such as the time needed to recognize the optotypes. For this reason, it is proposed that the assessment of visual quality provided by PPLs be performed by means (e.g., a relationship) of eye-tracking parameters such as recognition speed or the number of eye fixations while recognizing the optotypes.

Video-based eye tracking (ETs) allow the monitoring and recording of gaze positions by sending infrared light to the subject's eye and recording in a camera the light reflected from it. The bright pupil and the corneal reflections are processed using advanced image-processing software to obtain the instantaneous gaze direction with high accuracy and to calculate eye movements as saccades and fixations. Thanks to these systems, it is possible to study the influence of factors such as text characteristics or blur on eye movements. In the field of PPLs, this technology can be used to study how lateral refractive errors of PPLs affect eye fixations. A study analyzed differences in eye fixations when reading with PPLs vs single-vision lenses. One study studied differences in eye fixations while reading on a monitor screen with two different PPL designs. Another study studied differences in eye fixations while driving between PPL users in comparison with non-PPL users. All of these studies demonstrated that lateral unwanted refractive errors of PPLs affect eye fixation characteristics. For that reason, the proposed study aims to evaluate an eye-tracking-based method for assessing the quality of vision with progressive power lenses by analyzing test duration and eye fixation characteristics during a high-contrast visual acuity test.

The method of the proposed study included a study design with a prospective observational longitudinal double-masked study carried out to evaluate test duration and characteristics of eye fixation when performing VA test with 3 different PPL types. The study followed the principles of the Declaration of Helsinki; with full study approval obtained from the Clínico San Carlos Hospital Ethics Committee Review Board (CEIC) (15/361-P). All study subjects or participants were provided written informed consent before the start of the study, and at the end of the study, subjects were compensated with one pair of glasses.

This method of the proposed study included participants or the study sample that was made up of presbyopic participants of both genders who were older than 44 and had worn PPLs for at least six months before the start of the study. The inclusion criteria were: 1) Refractive error range from −6.00D to +5.00D with astigmatism less than or equal to 2.50D. 2) Near addition power from +1.00D to +3.00D. 3) Best-corrected VA better than 0.1logMAR (Logarithm of the Minimum Angle of Resolution) monocularly and 0.05 binocularly. 4) Anisometropia below 1.50D. Subjects were rejected if they had any ocular diseases, non-compensated binocular vision anomalies, medical conditions that could affect vision, or if they were undergoing any pharmacological treatments that might have affected the subjects' visual function. The sample size was calculated based on data from a preliminary study with 5 participants who met the same inclusion criteria as above. The calculation was performed using GRANMO sample size calculator version 7.12 (Institut Municipal d'Investigació Mèdica, Spain). Two-tailed testing with an alpha risk of 0.05, a beta risk of 0.1, and a dropout rate of 30% was set to estimate a sample size of 37 participants.

This method of the proposed study included a procedure where all participants underwent a full optometric assessment to check whether they met the inclusion criteria. The visual examination included VA measurement using the PVVAT test (Precision Vision, La Salle, III), subjective refraction at distance and near vision, stereo acuity assessment by the Titmus test, the Worth test, the Cover test, and ocular motility examination. After the optometrists determined the participant met the inclusion criteria, the fitting parameters and position of wear for the eye-tracker glasses were measured: pupillary position, segment height, back vertex distance, frame wrap angle, and pantoscopic tilt. Once these data were collected, the study PPL lenses were ordered. VA measurements incorporating an eye-tracking system for 3 different PPL designs at far and near distances were recorded in two separate two-hour visits. Two-minute breaks were taken between each PPL and gaze direction measurements to minimize the participant's fatigue.

This method of the proposed study included three different individualized free-form PPL designs: 1) A balanced design, PPL-Balance (Endless Steady Balance, IOT, Spain), 2) a lens with a wider field of view for near vision, PPL-Near (Endless Steady Near, IOT, Spain) and 3) a lens with a wider field of view for distance vision, PPL-Dis-Distance (Endless Steady Distance, IOT, Spain). The PPL's technical characteristics (cylinder and mean power distribution maps) for a Plano prescription, addition 2D, using standard position-of-wear parameters are shown in FIG. 1A. The lenses were placed on a specific clip-on frame which was attached to the eye-tracker glasses. This configuration allows for direct pupil registration without any interference from the PPL. Lenses were calculated using an advanced lens calculation software (FreeForm Designer, IOT, Spain) considering the fitting parameters of the PPLs attached to the ET glasses to reduce oblique aberrations and maintain a stable field of view regardless of the prescription and the addition power of each participant.

As a reminder, FIG. 1A shows a distribution 100 of the three regions of a PPL using a PPL balanced column A, then a PPL distance column B, then a PPL near column C. At the bottom of column A, the X, Y coordinate graph shows a far distance region 102 for viewing distant objects, a near distance region 106 below region 102 for viewing near objects, and a small intermediate distance region 104 between regions 102 and 106 for viewing at intermediate distance objects. Regions 102, 104 and 106 have far/distance vision area 112, intermediate vision area 114 and near vision are 116 which are 2 dimensional representations of the vision region sizes represented by brackets F1, I1 and N1 to the left of the X, Y coordinate graphs.

This method of the proposed study included eye tracking recording where binocular pupil position was recorded using a wearable eye-tracker system (Tobii Pro Glasses 3, Tobii AB, Sweden) with a sampling rate of 50 Hz. Recordings were made while participants were performing VA tests at distance and near vision using eye charts with logMAR (Logarithm of the Minimum Angle of Resolution) unit notation and a scoring criterion that assigns to the subject the VA corresponding to a given line when at least three letters are correctly recognized. The eye charts were composed of black optotypes over a white background with a luminance of 160 cd/m². Measurements were performed under photopic conditions (70 lux) in a uniformly illuminated room. Each eye chart was made up of a single row of 5 randomized optotypes (Sloan letters). The VA increments between eye charts was 0.10 logMAR. Subjects were asked to read the entire row of letters from left to right, beginning with an eye chart with a letter size 2-step greater than their best-correction VA until the maximum VA is reached. VA measurements were done for each of the three PPLs at three different gaze directions in the following sequence: centered, 12.5° off-axis dominant eye side, and 12.5° off-axis non-dominant eye side. The order of measurements with each PPL was randomized. Far-distance VA was recorded using three eye charts shown on a screen monitor (Asus LCD Monitor VP228HE 21.5″) located at 5.25 m. Each of the letters on each eye chart was separated from the other by an angle of 1°. To evaluate off-axis positions participants were seated on top of a big rotating platform with a chin rest to prevent head motion. Near-distance VA was assessed at 0.37 m using three eye charts for each gaze direction displayed on a screen (Microsoft Surface PRO 4 12.3″). The angular separation between letters in the same eye chart was 6.4°. Off-axis gaze directions were evaluated by moving the screen to three different positions. To prevent head motion and ensure participants used the central and lateral regions of the PPL, a table with a chin rest was used.

This method of the proposed study included recordings processed to calculate fixations using Tobii Pro Lab software (Tobii AB, Sweden) and the Tobii I-VT fixation filter. The velocity threshold was set according to a pilot study on 10 emmetropic non-presbyopic participants with the same experimental set-up as in the present work. Participants were asked to look at 5 optotypes of 0.4logMAR size at 5.25 m and 0.37 m.

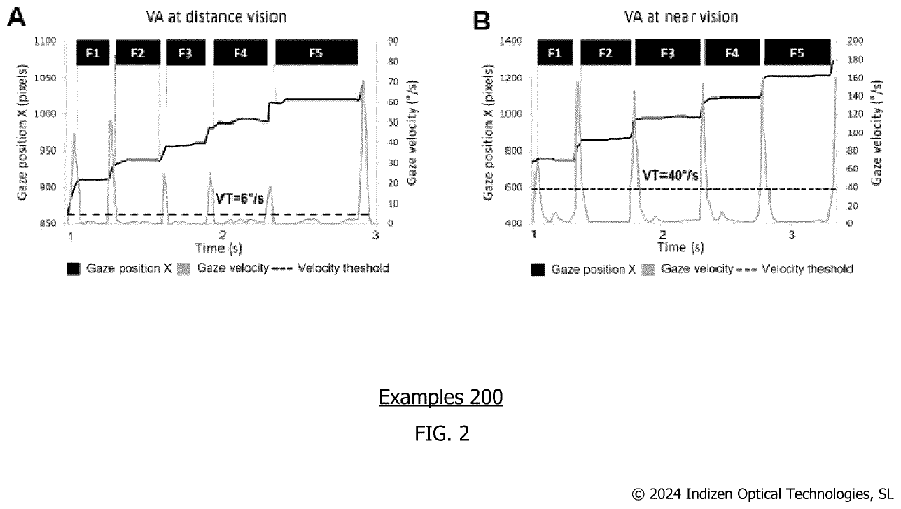

FIG. 2 shows experimental study fixation classification examples 200 from a gaze position signal along the Gaze position X (pixels) axis during a visual acuity (VA) test at distance vision in column A and near vision in column B. The velocity threshold was set to allow the algorithm to recognize the five fixations corresponding to the five optotypes displayed on the screen as indicated along the Time (s) axis at F1-F5. In the study, a velocity threshold of 40°/s was set for the near-distance VA task, and 6°/s was set for the far-distance VA task as seen in FIG. 2. To ensure a good quality of recordings, a data quality analysis was performed. The data quality of each recording was calculated as the number of time points in each recording for which valid gaze data was collected divided by the number of time points in the recording. The data quality of each recording was computed as the percentage of valid gaze data points relative to the total number of points recorded. As in other studies requiring very good quality in data recording, a threshold was set for data loss of 10%. Those participants with all recordings with valid data of 90% or more were included in the study.

The method of the proposed study included that all the statistical analyses performed in this study were carried out with Python 3.8.8 software using the statsmodels library. A three-way repeated measures ANOVA was used to assess differences in eye movements depending on the eye chart size, gaze direction, and PPL design, both for distance and near-distance VA measurements. To evaluate differences in VA scores depending on the gaze direction and the PPL design, a two-way repeated measure ANOVA was performed. The level of significance was set at 0.05 and the statistical power at 0.8. A Tukey HSD post-hoc test was used to determine which means differ significantly from each other. The variables analyzed were VA, test duration, complete fixation time, and the number of fixations.

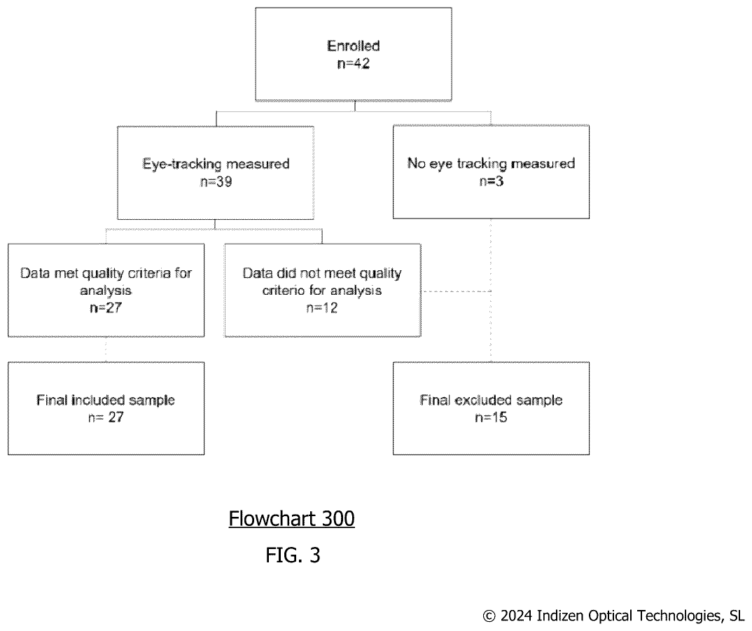

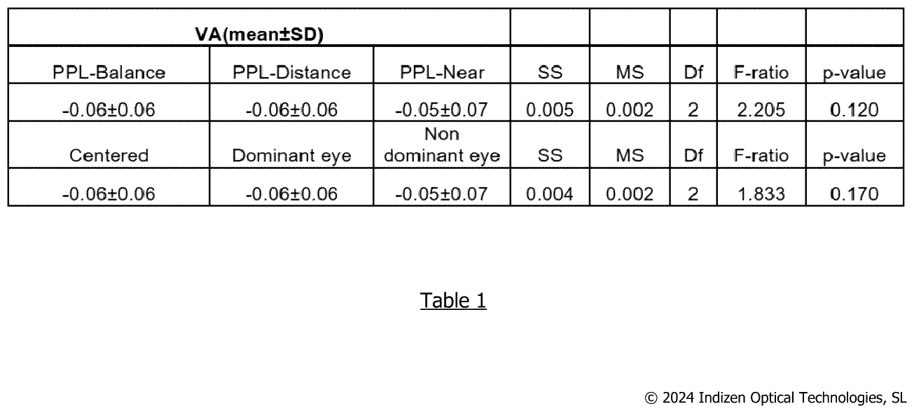

FIG. 3 shows a flowchart 300 for participant enrollment and data analysis for the experimental study. As shown in flowchart 300, the results of the proposed study included sample characteristics where a total of 42 subjects were enrolled in the study. Eye-tracking recordings were not attempted on 3 of them due to dry eye (n=1) and damaged lenses (n=2). Eye-tracking recordings were collected from a total of 39 subjects, 13 of them did not meet the 90% valid data threshold for all recordings and were discarded from the data analysis (FIG. 3). The final sample consisted of 27 subjects (15 men and 12 women) ranging in age from 44 to 65 years old (54+6). The average mean refractive error of the participants was −0.8+2.6D (ranging from −6D to +4.62D). There were 12 myopic participants, 10 participants with hyperopia, and 5 emmetropic participants. The participants' addition power ranged from 0.75D to 2.50D, with an average of 1.9+0.5D. The average mean percentage of valid data was 99.6+1.2 (ranging from 91.1 to 100) for far-distance VA recordings and 99.7+1.1 (ranging from 90.8 to 100) for near-distance VA recordings.

The results of the proposed study included far-distance VA that showed no statistical differences in distance vision for VA between PPLs and gaze direction. For example, Table 1 shows detailed statistics for VA analysis at distance vision. It shows two-way repeated measures ANOVA.

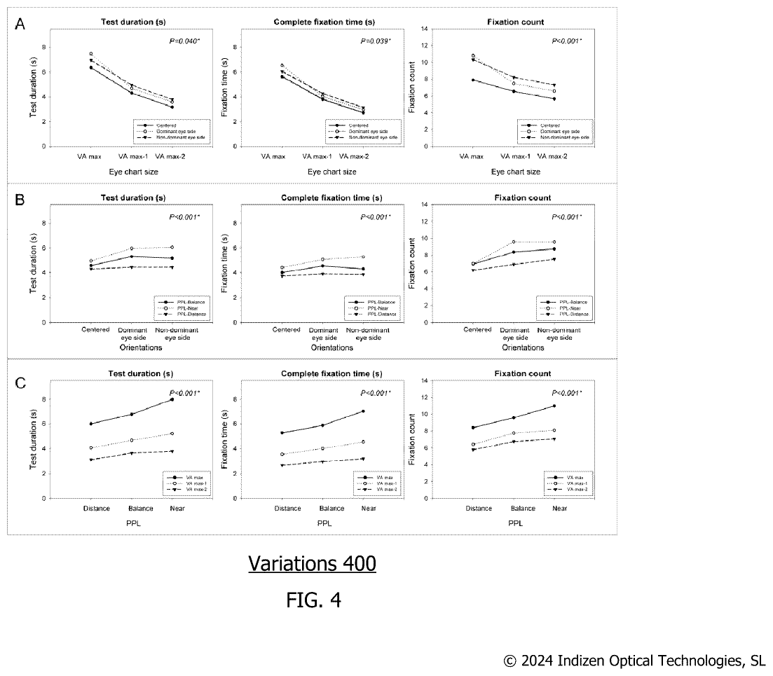

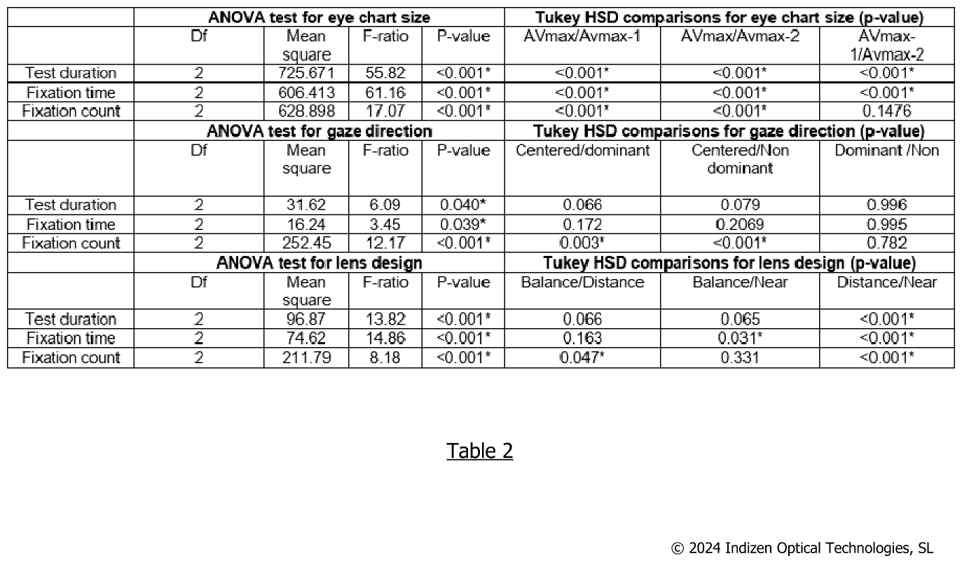

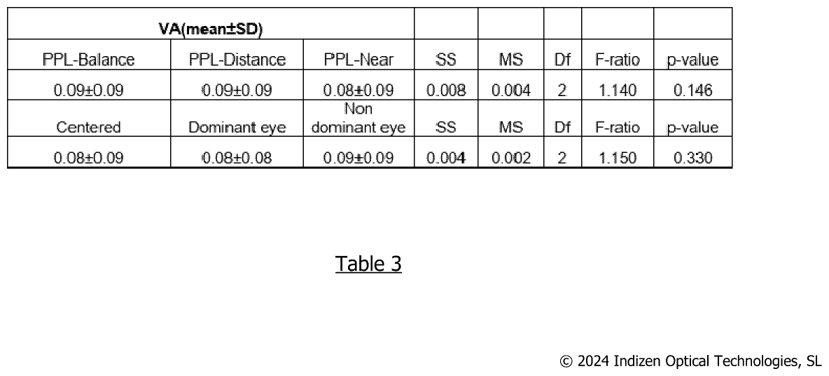

However, statistically significant differences in eye movements were found for the three factors analyzed: eye chart size, gaze direction, and PPL design. For example, FIG. 4 shows variations 400 in test duration, complete fixation time, and fixation count depending on: the interactions of eye chart size and gaze direction in row A, the gaze directions and PPL in row B, and PPL and eye chart in row C for far-distance VA task.

Also, Table 2 shows detailed statistics for FIG. 4. FIG. 4 and Table 2 show three-way repeated measures ANOVA test with pos-hoc comparisons using Tukey HSD method. As indicated by the “*”s, FIG. 4 and Table 2 shows significance at the 0.05 level. For the eye chart size, it was expected that when the letter became smaller the task difficulty increased, thus affecting the eye movements. Results confirmed that with a smaller optotype size, there was a statistically significant longer test duration, longer fixation time, and higher fixation count. Regarding the gaze directions, as the participant is forced to look through the lateral areas of the lens with blur, we would expect the increased recognition effort would affect the eye movement. Statistically significant longer test duration, longer complete fixation time, and a greater number of fixations were found for off-axis gaze directions relative to the central one. Finally, it was observed an effect of PPL design on eye movements. When the participants were using the PPL optimized for distance vision, statistically lower test duration, lower duration of fixations, and lower number of fixations were found as noted in FIG. 4 and Table 2.

The results of the proposed study included near-distance VA that were similar to those at distance vision, thus resulting in no statistical differences in near vision for VA between PPLs and gaze direction. For example, Table 3 shows detailed statistics for VA analysis at near vision. It shows two-way repeated measures ANOVA.

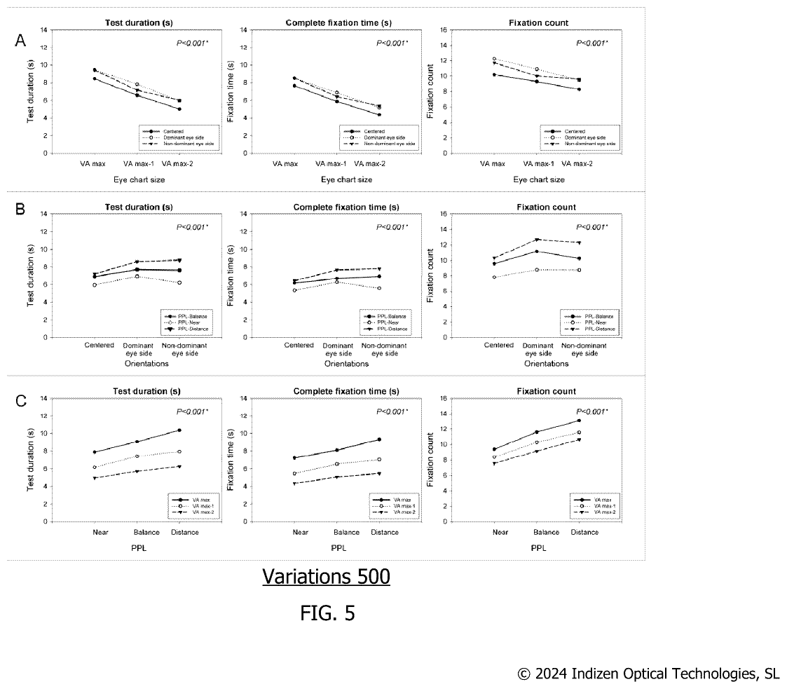

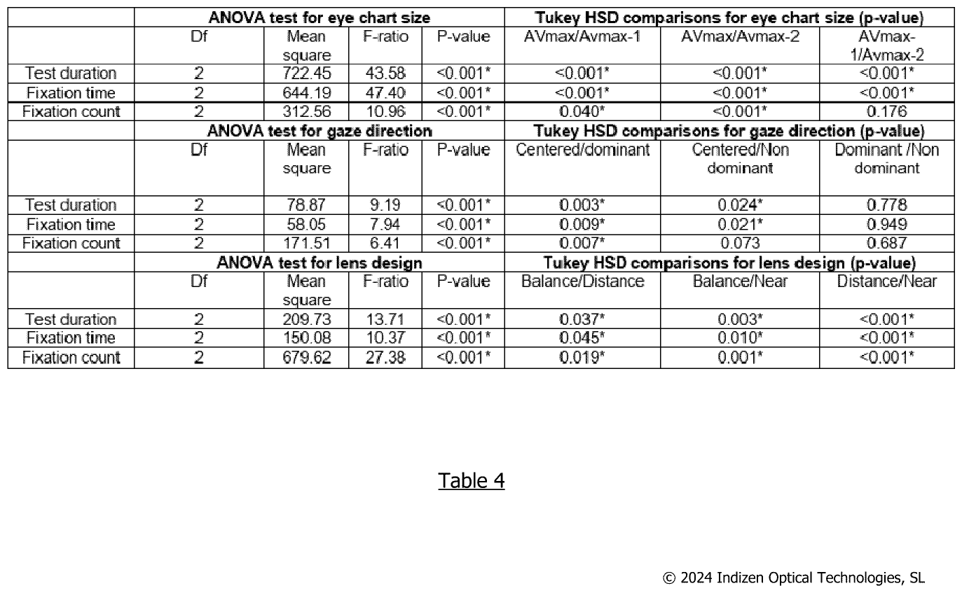

But, eye-tracker data showed statistically significant differences for the three factors analyzed: eye chart size, gaze direction, and progressive lens design. For example, FIG. 5 shows variations 500 in test duration, complete fixation time, and fixation count depending on: the interactions of eye chart size and gaze direction in row A, the gaze directions and PPL in row B, and PPL and eye chart in row C for near-distance VA task.

Also, Table 4 shows detailed statistics for FIG. 4. FIG. 4 and Table 2 show three-way repeated measures ANOVA test with pos-hoc comparisons using Tukey HSD method. As indicated by the “*”s, FIG. 5 and Table 2 show significance at the 0.05 level. As shown, smaller eye chart sizes resulted in longer test duration, longer fixation time, and more fixations compared to larger ones. Participants had more difficulty recognizing eye charts in off-axis gaze directions, resulting in longer test duration, complete fixation time, and more fixations compared to the central ones. And finally, regarding the PPL design, when participants were using the PPL optimized for near vision, results showed a reduction in test duration, total fixation time, and number of fixations compared to PPL-Balance and PPL-Near as noted in FIG. 5 and Table 4.

The study above presents a way of assessing the quality of vision provided by PPLs with different power distributions using an eye-tracking-based system during the VA measurement. The method is based on the analysis of test duration, fixation time, and the number of fixations required to recognize the different optotypes of standard eye charts. The study showed that when evaluating the far-distance VA of participants using a PPL design with a wider far-distance visual area, the test duration, fixation time, and the number of fixations are reduced. Similarly, a PPL design with a wider near area provided a lower test duration, lower fixation time, and lower number of fixations during the evaluation of near-distance VA. It should be noted that the values of standard VA obtained with different PPL designs were not different with statistical significance.

Although VA is considered a gold standard for the evaluation of optical quality, it seems not sufficient alone to evaluate the quality of vision. It is well-known that sometimes clinicians report patients with high VA complaining about poor vision quality. Specifically, regarding the performance of PPLs, several studies have tried to evaluate differences in VA between different PPL designs without success. An evaluation that evaluated differences in VA at eight different off-axis positions on 20 presbyopic participants with 2 different PPL designs and did not find differences in VA between them. On the other hand, an evaluation measured VA at the far and near regions in 95 presbyopic patients with a customized and a non-customized PPL design and, once again, the results did not show differences in VA between both PPLs.

Having a method that can determine differences between the visual performance provided by different PPL designs can help lens designers develop better lenses such as one having better or optimized visual performance as noted for FIG. 1B.

To eliminate any uncertainty based on reading tasks whose difficulty could be different from one experiment to another, the proposed study used, as a reading test, the standard eye charts that are used to evaluate visual acuity, under the same standardized conditions in which VA is clinically measured. So, a simple way to enhance the gold standard evaluation of VA may be using instead or also incorporating new metrics based on the characteristics of eye movements. The proposed study method included an eye-tracking system may be used while measuring VA and while using different PPL designs, and this method has proven to be sensitive enough to identify differences between designs and gaze direction.

This proposed study also incorporated the analysis of two factors that affect visual performance. Firstly, recognition difficulty depends on the eye chart size. In this sense, when the letter became smaller the task difficulty increases. As expected, results confirmed that with a smaller optotype size, there was a statistically significant longer test duration, longer fixation time, and higher fixation count than eye charts with a larger optotype size. Secondly, unwanted refractive results showed statistically significant longer test duration, longer complete fixation time, and a greater number of fixations for off-axis gaze directions in comparison with the central gaze direction.

In conclusion, based on the proposed study, the proposed eye-tracking method for assessing the quality of vision during a VA test can assess differences in test duration and eye fixation characteristics between PPL with different power distributions, being a more sensitive indicator of the quality of vision provided by the lenses than the standard VA evaluation, such as noted for FIG. 1B.

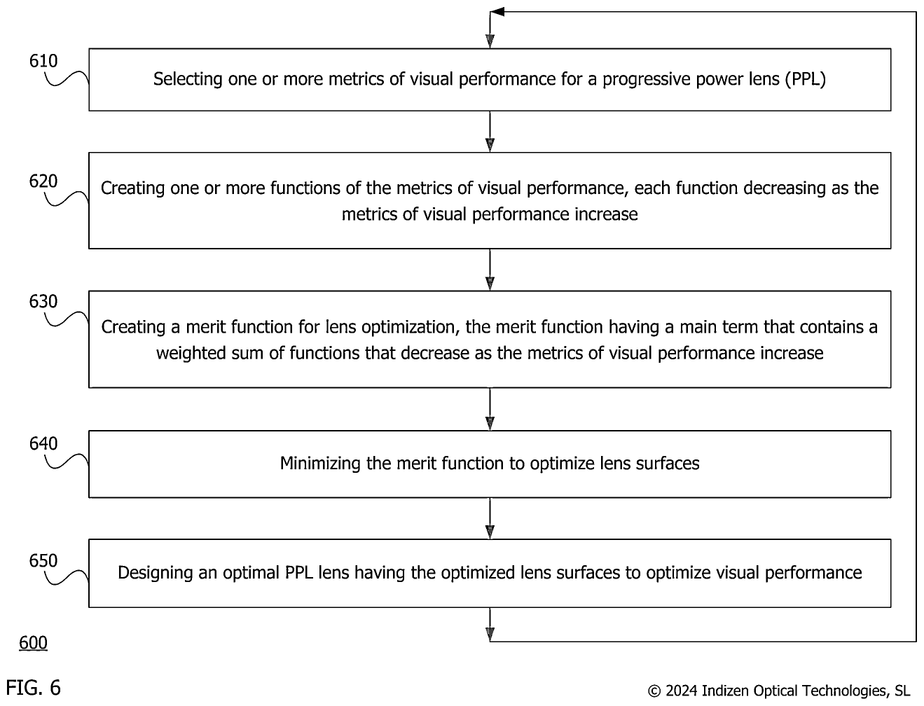

FIG. 6 is a flow diagram of an operating process 600 for optimizing visual performance of a spectacle lenses, such as a progressive power lens (PPL) using metrics of visual performance. Process 600 may be a process for optimizing, minimizing, designing, fabricating and/or creating a spectacle lenses, such as a PPL with optimized and/or minimized merit function and/or region sizes F1 and N1. Optionally it may also optimize and/or minimize size 11. Process 600 may be a process for or for part of designing, fabricating and/or manufacturing PPL 151. Process 600 starts at 610 and can end at 650, but the process can also be cyclical and return to any of steps 610, 620 or 630 after step 640 or 650, such as to optimize, minimize, design or fabricate another lens having optimized visual performance. These multiple return options are represented by a single arrow going from step 650 to step 610.

The process 600 starts at step 610 where one or more metrics of visual performance is selected for the spectacle lenses, such as a PPL. The spectacle lenses may be PPL 151. The visual performance metrics may include reading time and number of fixations instead of visual acuity errors, visual power errors and astigmatism errors. The visual performance metrics can be related to second order power and astigmatic errors either through fitting of experimental data or through modelling, where certain merit functions and/or regions in the lens, that can be defined in terms of angular field-of view or in terms of collections of points in either of the lens surfaces. These merit functions and/or regions can be given a merit value as the sum of the values of the visual performance metrics times a weight for each point or viewing direction within each given region, such as in function (4) and/or (6).

Selecting at step 610 may include establishing a relationship between power errors and astigmatic errors and the metrics of visual performance, either through experiment or modeling, such as by creating function (4) and/or (6). This establishing may include either directly measured, as reading time, shape recognition time, etc., or eye-movement parameters obtained with eye-tracking technology that have a direct relationship with visual performance, as number of fixations, fixation time, total fixation time, and number of regressions. Selection at step 610 can be received by a computing device such as by being input by an optometrist or user of the computing device.

After step 610, at step 620 one or more functions of the metrics of visual performance is created, each function decreasing as the metrics of visual performance increase. That is, as visual performance gets better, the metric is minimized. The one or more functions may be f_{F}, f_{I}, and f_{N} (or g) for 1, 2 or 3 of far, intermediate and near regions, where each function has a function value that decreases as the values of the metrics of visual performance of step 610 increase, such as noted for functions (4)-(7). The function may be the best fit for decreasing reading time (RT) and/or number of fixations (NF) for increasing blurs; for one or more regions of a single focal or PPL having that or those regions. Creating at step 620 may include using trial participants solve function (4) and/or (6) for f_{F}, f_{I}, and f_{N} (or g).

At step 620, creating the one or more functions may include: establishing an experimental relationship between the metric reading time RT and reading time blur (e.g., as noted for function (4) and/or (5)) that when minimized for reading time (e.g., as per step E), determines a minimized merit function and/or total number of points N_{F}, N_{I}, and N_{N} of index points i, j and k inside each of the far, intermediate and near vision regions. The reading time blur may be artificially introduced to participants of a clinical trial asked to read a text using with trial lenses with different levels of blur produce with different amounts of power and astigmatism errors, such as using function (4).

At step 620, creating the one or more functions may include: establishing an experimental relationship between the metric number of fixations NF per character and a fixations per character blur (e.g., as noted for function (6) and/or (7)) that when minimized for fixations per character (e.g., as per step E), determines a minimized merit function and/or total number of points N of index points i inside the far vision region. The fixations per character blur may be artificially introduced to participants of a clinical trial asked to read a text using with trial lenses with different levels of blur produce with different amounts of power and astigmatism errors, such as using function (6).

The functions of the metrics of visual performance and second-order power and astigmatic errors may be obtained for cases where maximum visual acuity is not needed, either because the lens is intended for low-demanding visual tasks or for users with high tolerance to defocus, for example subjects with low-vision condition, as noted herein.

The functions of the metrics can be created and/or calculated by a computing device running software. The functions of the metrics may be computed and/or calculated as described herein.

After step 620, at step 630 a merit function for lens optimization is created, the merit function having a main term that contains a weighted sum of functions that decrease as the metrics of visual performance increase. The merit function may have a main term that contains a weighted ϕ, ι and ν sums from i to N_{F}, j to N_{I}, k to N_{N} of functions f_{F}, f_{I}, f_{N} (or g) of step 620 that decrease as the metrics of visual performance increase. The weighted sum or each function may be each of the 3 terms of function (5) running across or including a set of viewing directions or a set of points from i to N_{F}, j to N_{I}, k to N_{N} with a one-to one correspondence with the set of viewing directions from i to N_{F}, j to N_{I}, k to N_{N}, as noted for function (5) and/or (7). The merit function may have terms other than the main term for the reduction of less-importance aberrations. The merit function may be function (5) and/or (7). The merit function may include eye tracking parameters, metrics of visual performance and/or parameters describing visual performance such as reading speed/time and number of fixations but excludes visual acuity errors, visual power errors and astigmatism errors. The merit function can be created and/or computed by a computing device running software. The merit function may be created and/or computed or calculated as described herein.

After step 630 at step 640 the merit function is minimized to optimize lens surfaces. Minimizing at step 640 may be minimizing the merit function of step 630. Minimizing may include determining region sizes F1, I1 and N1 of the PPL. Minimizing at step 640 may include minimizing the weighted sums of the 3 functions of function (5) or (7) with one or more minimization algorithms or optimization algorithms to create, calculate or optimize the number of a subset of the points or sums from i to N_{F}, j to N_{I}, k to N_{N}, such as to determine or optimize what are lens surface region sizes F1, I1 and N1 as those three sums.

In some cases, minimizing the metric function at step 640 may include or be minimizing the experimental relationship between reading time (or reading speed) and reading time blur (e.g., of merit function (5)) that when minimized for reading time (e.g., see step E) determines: a total number of a subset of the points N_{F} of index points i inside the far vision region 152, wherein the total number of a subset of the points N_{F} is the far vision region size F2; a total number of a subset of the points N_{I} of index points j inside the intermediate vision region 154, wherein the total number of a subset of the points N_{I} is the intermediate vision region size 12; and a total number of a subset of the points N_{N} of index points k inside the near vision region 156, wherein the total number of a subset of the points N_{N} is the near vision region size N2.

In some cases, minimizing the metric function at step 640 may include or be minimizing the experimental relationship between number of fixations per character and a fixations per character blur (e.g., of merit function (7)) that when minimized for fixations per character (e.g., see step E) determines: a total number of a subset of the points N of index points i inside the far vision region 152, wherein the total number of a subset of the points N is the far vision region size F2.

In either case, the visual performance metrics may include reading time RT and/or number of fixations NF, but exclude visual acuity errors, visual power errors and astigmatism errors.

Minimizing the reading time at step 640 may provide comfort, speed/time of execution, or agility, to the visual task. Minimizing the number of fixations per character at step 640 may minimize the number of fixations during reading of a far-located text within a 40° Field of view to provide better or optimized visual performance for far vision reading.

Minimizing the reading time at step 640 may include running an optimization algorithm (not shown) to minimize the merits corresponding to each of the far, intermediate and near vision regions, using as minimization parameters the coefficients describing one or the two surfaces of the lens. Minimizations algorithms that can be used to minimize the type of merit functions may be well known algorithms to any expert in the field. For example, a well suited one is the gradient descent based method Broyden-Fletcher-Goldfarb-Shanno (BFGS), that can uses the numerical computation of the Hessian to find descent direction. Global methods such as genetic minimization algorithms or simulated annealing are also very effective to find global minima of the merit functions described below.

Minimizing at step 640 may not include smallest power values for power and smallest astigmatic errors; may include increased reading speed, reading comprehension, based on static or dynamic testes involving geometrical shapes, signs, symbols or images that are presented or displayed in a digital display; may include the capacity for perform a visual task comfortably, effortlessly, rapidly and/or swiftly; may be where performing the visual task provides increased comfort, speed/time of execution and/or agility to the visual task; and may correlate with eye movement statistics involving low number of fixations, low number of regressions, and small-duration fixations. At step 640 the merit function can be minimized by a computing device running software. At step 640 the merit function may be minimized or optimized as described herein.

Next, at step 650 an optimal spectacle lenses, such as a PPL lens is designed having the optimized lens surfaces to optimize visual performance. Designing at step 650 may include preparing, fabricating or creating an optimal spectacle lenses, such as a PPL lens having the optimized lens surfaces of step 640. Designing at step 650 may fabricate or manufacture a lens using the minimized merit function. Designing at step 650 may be fabricating a PPL having the lens surface having the minimized metric function and/or region sizes F1, I1 and N1 to optimize visual performance.

At step 650 the spectacle lenses, such as a single vision lens or PPL may be designed by a computing device running software. At step 640 the spectacle lenses, such as a single vision lens or PPL may be designed by a lens fabrication system. At step 650 a spectacle lenses, such as a single vision lens or PPL may be manufactured by incorporating the results of the calculation at step 640 into a lens surface description file and guiding a cutting tool to generate a surface of the lens according to the lens surface description file. In other cases, the lens may be 3-dimensionally printed.

Designing at 650 may be included in step 640 such as where once the minimization is done, the design phase is over. In this case, the free-form surface and the thickness are fully determined for the lens (the front surface is that of the blank, and it is fixed). Designing at 650 may include some post processing after optimization, such as lens rotation, generation of the final surface file, and other operations.

In some cases, step 640 may be repeated for each spectacle lenses or PPL customer or with various outputs from any or all of steps 610-630 to re-create the merit function or minimizations of that function.

In some cases, step 630, 640 and/or 650 includes evaluating the need of a particular patient, customer or individual with a life-style questionnaire; or with eye tracking measurements at a laboratory or optical shop to get the reading times and/or number of fixations; and/or visual performance and the person's needs.

Process 600 may include designing a lens shape, surface shape, optical power, prescription distribution map across the surface of the lens based on the technologies described herein. The design may use a wearer's accommodation or prescription. Designing at 600 may include designing a lens to meet a set of performance requirements and constraints, including cost and manufacturing limitations. Parameters include surface profile types (spherical, aspheric, holographic, diffractive, etc.), as well as radius of curvature, distance to the next surface, material type and optionally tilt and decenter. The process may be computationally intensive, using ray tracing or other techniques to model how the lens affects light that passes through it.

In some cases, sums runs from 1 to each of N_{F}, N_{I} and N_{N} and the variables i, j and k are indexes counting the points considered at the regions having N_{F}, N_{I} and N_{N} points. These points are typically uniformly distributed, and cover distance, intermediate and near regions much larger than the areas depicted in FIG. 1A and/or 1B. When determining the size of the areas as in FIG. 1B, it is possible to compute whatever property (Sphere, Cylinder→Blur, Visual Acuity, Visual Performance) and only counts those points for which the metric is “acceptable” to find the areas or sizes F2, 12 and N2. The numbers N_{F}, N_{I} and N_{N} may be fixed numbers during process 600 from which the region sizes F2, 12 and N2 are a subset of those points. In principle, the more dense the gride, the better (since N_{F}, N_{I} and N_{N} will be large) but not to very large values because it is difficult to optimize the lenses in a reasonable time with a grid that is too dense.

In some cases, visual performance is a better metric for lens optimization than blur or power errors because visual performance defines in a clearer way when a lens is suitable for some task or for a set of tasks such as noted in FIGS. 1A-1C. The evidence for this statement is the experimental study described herein where three lenses with different power distributions cannot be differentiated in terms of visual acuity but can be differentiated in terms of visual performance. The lesson here is that using visual performance to design and/or characterize lenses provides lens designs that better fit the user's needs.

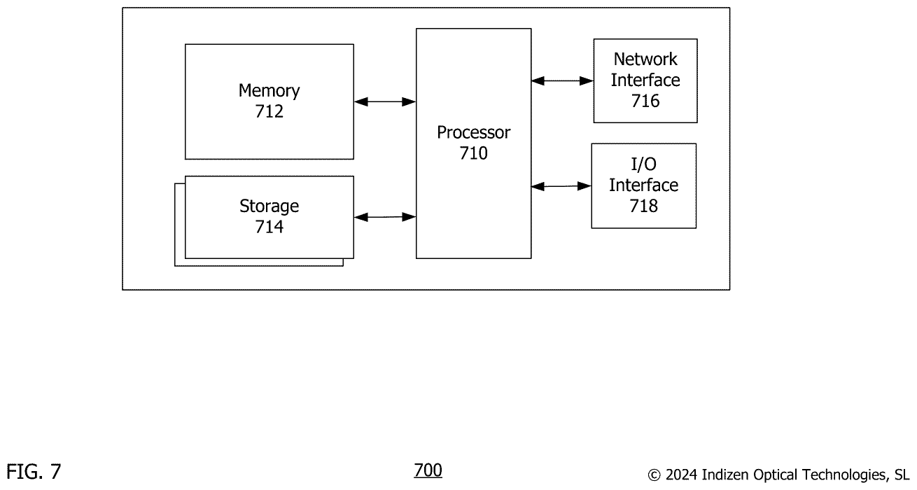

FIG. 7 is a block diagram of a computing device 700. The computing device 700 may be representative of any of the components of technology for configuring ophthalmic lenses that reduce oblique aberrations as noted herein. Device 700 may be a specialized computing device that is part of system, device, lens production and/or process for optimizing visual performance of a spectacle lenses, such as a PPL as noted herein. It may control other components of the spectacle lenses or PPL system, device, lens production and/or method. In some cases, the computing device 700 may be a desktop or laptop computer, a server computer, a computer workstation, or other computer. The computing device 700 includes software and hardware for providing functionality and features described herein, such as for optimizing visual performance of a spectacle lenses, such as a PPL. These computing devices may run an operating system, including variations of the Linux, Microsoft Windows, and Apple Mac operating systems. The methods described herein may be implemented as software stored on machine readable storage media in a storage device included with or otherwise coupled or attached to a computing device.

The computing device 700 may include one or more of logic arrays, memories, analog circuits, digital circuits, software, firmware and processors. The hardware and firmware components of the computing device 700 may include various specialized units, circuits, software and interfaces for providing the functionality and features described herein. For example, device 700 may perform control and processing of configuring ophthalmic lenses that reduce oblique aberrations as noted herein. This includes producing a lens as noted herein, such as at 695.

The computing device 700 has a processor 710 coupled to a memory 712, storage 714, a network interface 716 and an I/O interface 718. The processor 710 may be or include one or more microprocessors, field programmable gate arrays (FPGAs), application specific integrated circuits (ASICs), programmable logic devices (PLDs) and programmable logic arrays (PLAs). The memory 712 may be or include RAM, ROM, DRAM, SRAM and MRAM, and may include firmware, such as static data or fixed instructions, BIOS, system functions, configuration data, and other routines used during the operation of the computing device 700 and processor 710. The memory 712 also provides a storage area for data and instructions associated with applications and data handled by the processor 710, such as data and instructions associated with the control and processing of calculating a new merit function or optimization that takes into account the accommodation capacity of the user as noted herein. As used herein the term “memory” corresponds to the memory 712 and explicitly excludes transitory media such as signals or waveforms.

The storage 714 provides non-volatile, bulk or long-term storage of data or instructions in the computing device 700, such as data and instructions associated with the control and processing of calculating a new merit function or optimization that takes into account the accommodation capacity of the user as noted herein. The storage 714 may take the form of a magnetic or solid state disk, tape, CD, DVD, or other reasonably high capacity addressable or serial storage medium. Multiple storage devices may be provided or available to the computing device 700. Some of these storage devices may be external to the computing device 700, such as network storage or cloud-based storage. As used herein, the terms “storage” and “storage medium” correspond to storage 714 and explicitly exclude transitory media such as signals or waveforms. In some cases, such as those involving solid state memory devices, memory 712 and storage 714 may be a single device. The memory 712 and/or storage 714 can include an operating system executing the data and instructions associated with configuring ophthalmic lenses that reduce oblique aberrations as noted herein.

The network interface 716 includes an interface to a network such as a network that can be used to communicate network packets, network messages, telephone calls, faxes, signals, streams, arrays, and data and instructions associated with the control and processing of calculating a new merit function or optimization that takes into account the accommodation capacity of the user as described herein. The network interface 716 may be wired and/or wireless. The network interface 716 may be or include Ethernet capability.

The I/O interface 718 interfaces the processor 710 to peripherals (not shown) such as displays, video and still cameras, microphones, user input devices (for example, touchscreens, mice, keyboards and the like). The I/O interface 718 interface may support USB, Bluetooth and other peripheral connection technology. In some cases, the I/O interface 718 includes the peripherals, such as displays and user input devices, for user accessed to data and instructions associated with the control and processing of configuring ophthalmic lenses that reduces oblique aberrations as noted herein.

In some cases, storage 714 is a non-volatile machine-readable storage medium that includes computer readable media including magnetic storage media, optical storage media, and solid state storage media. It should be understood that the software can be installed in and sold with a system, method and/or the other published content or components for optimizing visual performance as noted herein. Alternatively, the software can be obtained and loaded into the data and instructions associated with optimizing visual performance as noted herein, including obtaining the software via a disc medium or from any manner of network or distribution system, including from a server owned by the software creator or not owned but used by the software creator. The software can be stored on a server for distribution locally via a LAN and/or WAN, and/or to another location via a WAN and/or over the Internet.

By providing data and instructions associated with the control and processing of optimizing visual performance as noted herein, those data and instructions increase computer efficiency because they provide a quicker, automated and more accurate optimizing visual performance using visual performance metrics that may include reading time and number of fixations, but exclude visual acuity errors, visual power errors and astigmatism errors. They, in fact, provide better methods, devices, lenses, computer instructions and systems as noted herein.

The technology described herein for optimizing visual performance may be implemented on a computing device that includes software and hardware. A computing device refers to any device with a processor, memory and a storage device that may execute instructions including, but not limited to, personal computers, server computers, computing tablets, smart phones, portable computers, and laptop computers. These computing devices may run an operating system, including, for example, variations of the Linux, Microsoft Windows, and Apple MacOS operating systems.

The methods described herein may be implemented and stored as software on a machine readable storage media in a storage device included with or otherwise coupled or attached to a computing device. That is, the software may be stored on electronic, machine readable media. These storage media include magnetic media such as hard disks, optical media such as compact disks (CD-ROM and CD-RW) and digital versatile disks (DVD and DVD±RW); and silicon media such as solid-state drives (SSDs) and flash memory cards; and other magnetic, optical or silicon storage media. As used herein, a storage device is a device that allows for reading from and/or writing to a storage medium. Storage devices include hard disk drives, SSDs, DVD drives, flash memory devices, and others.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for optimizing visual performance of a spectacle lens using metrics of visual performance, the method comprising;
selecting one or more metrics of visual performance for the spectacle lens;
creating one or more functions of the metrics of visual performance, each function having a function value that decreases as the values of the metrics of visual performance increase;
creating a merit function for lens optimization, the merit function having a main term that contains a weighted sum of functions that decrease as the metrics of visual performance increase, the weighted sum of functions including a set of viewing directions or a set of points with a one-to one correspondence with the set of viewing directions;
minimizing the merit function to optimize lens surfaces; and
designing an optimal spectacle lens having the optimized lens surfaces to optimize visual performance.

2. The method of claim 1, wherein the spectacle lens is a progressive power lens (PPL) having a far vision region having a far vision region size, an intermediate vision region having an intermediate vision region size and near vision region having a near vision region size; wherein the visual performance metrics are related to second order power and astigmatic errors either through fitting of experimental data or through modelling; wherein certain regions in the lens are defined in terms of angular field-of view or in terms of collections of points in either of the lens surfaces; and wherein the certain regions are given a merit value as the sum of the values of the visual performance metrics times a weight for each point or viewing direction within each given region.

3. The method of claim 1, wherein creating the one or more functions includes one of:
establishing an experimental relationship between the metric reading time and reading time blur that when minimized for reading time, determines a total number of a subset of points N_{F}, N_{I}, and N_{N} of index points i, j and k inside each of the far, intermediate and near vision regions;
wherein the reading time blur is artificially introduced to participants of a clinical trial asked to read a text using with trial lenses with different levels of blur produce with different amounts of power and astigmatism errors; or
establishing an experimental relationship between the metric number of fixations per character and a fixations per character blur that when minimized for fixations per character, determines a total number of a subset of points N of index points i inside the far vision region;
wherein the fixations per character blur is artificially introduced to participants of a clinical trial asked to read a distant text subtending at least 40° vertically and 40° horizontally, using with trial lenses with different levels of blur produce with different amounts of power and astigmatism errors.

4. The method of claim 1, wherein creating one or more functions includes creating one or both of the functions (4) or (6) which are:
$$RT = {f}_{F} ( {t}_{s} , {E}_{P} , {E}_{A} ) \qquad ( 4 )$$
where RT is reading time, t_{S} is the type size, E_{P}=(P−P₀) is the power error and E_{A}=(C−C₀) is the astigmatic error, wherein the function f_{F} fits the experimental data when the text is presented at a distance larger than 6 meters, and wherein there are similar functions f_{I} and f_{N} for intermediate and near distances;
or
$$NF = g ( {t}_{s} , {E}_{P} , {E}_{A} ) \qquad ( 6 )$$
where NF is the number of fixations, t_{S} is the type size, and E_{P} and E_{A} are the power and astigmatic errors, respectively, wherein the function g fits the experimental data when the text is presented at a distance larger than 6 meters.

5. The method of claim 1, wherein the merit function includes a main term that contains a weighted φ, ι and ν sums from i to N_{F}, j to N_{I}, k to N_{N} of functions f_{F}, f_{I}, f_{N} that decrease as the metrics of visual performance increase.

6. The method of claim 1, wherein the merit function includes the weighted sum of 3 functions running across a set of viewing directions or a set of points from i to N_{F}, j to N_{I}, k to N_{N} with a one-to one correspondence with the set of viewing directions from i to N_{F}, j to N_{I}, k to N_{N}; and
wherein minimizing includes minimizing the weighted sums of the 3 functions a minimization algorithm to optimize a subset of a number of points from i to N_{F}, j to N_{I}, k to N_{N}, to optimize three lens surface region sizes.

7. The method of claim 1, wherein one of the metrics or the merit function include reading time and number of fixations but exclude visual acuity errors, visual power errors and astigmatism errors.

8. The method of claim 1, wherein creating the merit function includes creating one or both of the merit functions (5) or (7) which are:
$$M = {\sum }_{i = 1}^{{N}_{F}} {ϕ}_{i} {f}_{F} ( {E}_{{P}_{i}} , {E}_{{A}_{i}} ) + {\sum }_{j = 1}^{{N}_{I}} {ι}_{j} {f}_{I} ( {E}_{{P}_{j}} , {E}_{{A}_{j}} ) + {\sum }_{i = 1}^{{N}_{N}} {v}_{i} {f}_{N} ( {E}_{{P}_{k}} , {E}_{{A}_{k}} ) + Φ , \qquad ( 5 )$$
where the indexes i, j and k will label points inside each of three regions, where a subset of each of N_{F}, N_{I} and N_{N} the total number of points in each region define sizes F2, I2 and N2, respectively, where each point has a corresponding viewing direction, sharing the same index, and for each viewing direction the lens will have some power errors, E_{P}_{ᵢ}, E_{P}_{ⱼ} and E_{P}_{ₖ}, and some astigmatic error, E_{A}_{ᵢ}, E_{A}_{ⱼ} and E_{A}_{ₖ}, where φ, ι and ν are weights for the far, intermediate and near regions, respectively, and any parameters other than the second-order errors are omitted in the functions “f” providing the reading time, and wherein Φ stands for a portion of the merit function that may consider structural parameters of the progressive lens;
or for single-vision lenses
$$M = {\sum }_{i = 1}^{N} {γ}_{i} g ( {E}_{{P}_{i}} , {E}_{{A}_{i}} ) + Φ , \qquad ( 7 )$$
where the index i labels the points/gaze directions within a 20° Cone around the visual axis, Yi are weights for the i-point and E_{P}_{ᵢ} and E_{A}_{ᵢ} are the power and astigmatic errors for point/gaze direction i, and wherein the remaining merit function Φ takes into consideration other, secondary lens performance factors.

9. The method of claim 1, wherein minimizing the merit function includes determining a far vision region size, an intermediate vision region size and near vision region size of a spectacle lens.

10. The method of claim 1, wherein minimizing includes:
minimizing an experimental relationship between reading time and blur that when minimized for reading time determines: a total number of a subset of points N_{F} of index points i inside the far vision region, wherein the total number of a subset of points N_{F} is the far vision region size F2; a total number of a subset of points N_{I} of index points j inside the intermediate vision region, wherein the total number of a subset of points N_{I} is the intermediate vision region size I2; and a total number of a subset of points N_{N} of index points k inside the near vision region, wherein the total number of a subset of points N_{N} is the near vision region size N2; or
minimizing an experimental relationship between number of fixations per character and a fixations per character blur that when minimized for fixations per character determines: a total number of a subset of points N of index points i inside the far vision region, wherein the total number of a subset of points N is the far vision region size F2.

11. The method of claim 1, wherein minimizing the merit function includes minimizing one or both of merit functions (5) or (7) which are:
$$M = {\sum }_{i = 1}^{{N}_{F}} {ϕ}_{i} {f}_{F} ( {E}_{{P}_{i}} , {E}_{{A}_{i}} ) + {\sum }_{j = 1}^{{N}_{I}} {ι}_{j} {f}_{I} ( {E}_{{P}_{j}} , {E}_{{A}_{j}} ) + {\sum }_{i = 1}^{{N}_{N}} {v}_{i} {f}_{N} ( {E}_{{P}_{k}} , {E}_{{A}_{k}} ) + Φ , \qquad ( 5 )$$
where the indexes i, j and k will label points inside each of three regions, where N_{F}, N_{I} and N_{N} the total number of points in each region which may have a subset of that total number that define sizes F2, 12 and N2, respectively, where each point has a corresponding viewing direction, sharing the same index, and for each viewing direction the lens will have some power errors, E_{P}_{ᵢ}, E_{P}_{ⱼ} and E_{P}_{ₖ}, and some astigmatic error, E_{A}_{ᵢ}, E_{A}_{ⱼ} and E_{A}_{ₖ}, where ϕ, ι and ν are weights for the far, intermediate and near regions, respectively, and any parameters other than the second-order errors are omitted in the functions “f” providing the reading time, wherein Φ stands for a portion of the merit function that may consider structural parameters of the progressive lens;
or for single-vision lenses
$$M = {\sum }_{i = 1}^{N} {γ}_{i} g ( {E}_{{P}_{i}} , {E}_{{A}_{i}} ) + Φ , \qquad ( 7 )$$
where the index i labels the points/gaze directions within a 20° cone around the visual axis, γᵢ are weights for the i-point and E_{P}_{ᵢ} and E_{A}_{ᵢ} are the power and astigmatic errors for point/gaze direction i. wherein the remaining merit function Φ takes into consideration other, secondary lens performance factors.

12. The method of claim 1, wherein designing includes fabricating a PPL having the far vision region size, the intermediate vision region size and the near vision region size to optimize visual performance.

13. A progressive power lens (PPL) spectacle lens having a far vision region size, an intermediate vision region size and a near vision region size optimized using a merit function incorporating visual performance metrics that are either: 1) directly measured, as reading speed or shape recognition time; 2) or eye-movement parameters obtained with eye-tracking technology that have a direct relationship with visual performance, the parameters including a number of fixations, a fixation time, a total fixation time, or a number of fixation regressions, wherein the visual performance metrics are related to second order power and astigmatic errors either through fitting of experimental data or through modelling, wherein the far vision region size, the intermediate vision region size and the near vision region size are based on a merit function: 1) defined in terms of angular field-of view or in terms of collections of points in at least one lens surface, 2) with a given a merit value as the sum of the values of the visual performance metrics times a weight for each point or viewing direction within each given region, and 3) with merit values that are minimized using an optimization algorithm that uses as minimization parameters, coefficients describing the at least one surface of the lens.

14. The PPL spectacle lens of claim 13, wherein the visual performance metrics include reading time and number of fixations but exclude visual acuity errors, visual power errors and astigmatism errors.

15. The PPL spectacle lens of claim 13, wherein the at least one surface is both a front and a back surface of the lens.

16. A progressive power lens (PPL) spectacle lens having a far vision region size determined by a total number of a subset of points N_{F}, an intermediate vision region size determined by a total number of a subset of points N_{I}, and a near vision region size determined by a total number of a subset of points N_{N} that provide optimized visual performance by minimizing a metric function by one of:
minimizing the experimental relationship between reading time and reading time blur that when minimized for reading time determines:
a total number of a subset of points N_{F} of index points i inside the far vision region, wherein the total number of a subset of points N_{F} is the far vision region size;
a total number of a subset of points N_{I} of index points j inside the intermediate vision region, wherein the total number of a subset of points N_{I} is the intermediate vision region size; and
a total number of a subset of points N_{N} of index points k inside the near vision region, wherein the total number of a subset of points N_{N} is the near vision region size; or
minimizing the experimental relationship between the number of fixations per character and a fixations per character blur that when minimized for fixations per character determines;
a total number of a subset of points N of index points i inside the far vision region, wherein the total number of a subset of points N is the far vision region size.

17. The PPL spectacle lens of claim 16, wherein the visual performance metrics include reading time and number of fixations but exclude visual acuity errors, visual power errors and astigmatism errors.

18. The PPL spectacle lens of claim 16, wherein one of:
minimizing the reading time provides comfort and speed of execution to the visual task; or
minimizing the number of fixations per character minimizes the number of fixations during reading of a far-located text within a 40° Field of view to provide better visual performance for far vision reading.

19. A computing device comprising a storage medium having instructions stored thereon for optimizing visual performance by minimizing a metric function to optimize a far vision region size determined by a total number of a subset of points N_{F}, an intermediate vision region size determined by a total number of a subset of points N_{I}, and a near vision region size determined by a total number of a subset of points N_{N} of a progressive power lens (PPL) spectacle lens by one of:
minimizing the experimental relationship between reading time and reading time blur that when minimized for reading time determines:
a total number of a subset of points N_{F} of index points i inside the far vision region, wherein the total number of a subset of points N_{F} is the far vision region size;
a total number of a subset of points N_{I} of index points j inside the intermediate vision region, wherein the total number of a subset of points N_{I} is the intermediate vision region size; and
a total number of a subset of points N_{N} of index points k inside the near vision region, wherein the total number of a subset of points N_{N} is the near vision region size; or
minimizing the experimental relationship between the number of fixations per character and a fixations per character blur that when minimized for fixations per character determines;
a total number of a subset of points N of index points i inside the far vision region, wherein the total number of a subset of points N is the far vision region size.

20. The computing device of claim 19, wherein the visual performance metrics include reading time and number of fixations but exclude visual acuity errors, visual power errors and astigmatism errors.
